(19) United States
(12) Patent Application Publication
(10) Pub. No.: US 2015/0005406 A1
(43) Pub. Date: Jan. 1, 2015

(54) URETHANE (METH)ACRYLATE AND MOISTURE-PROOF INSULATING COATING MATERIAL

(71) Applicant: SHOWA DENKO K.K., Minato-ku, Tokyo (JP)

(72) Inventors: Kazuhiko Ooga, Minato-ku (JP); Hiroto Kouka, Minato-ku (JP); Kai Suzuki, Minato-ku (JP)

(73) Assignee: SHOWA DENKO K.K., Minato-ku, Tokyo (JP)

(21) Appl. No.: 14/366,566

(22) PCT Filed: Feb. 1, 2013
(86) PCT No.: PCT/JP2013/052383

§ 371 Date: Jun. 18, 2014

(30) Foreign Application Priority Data
Feb. 7, 2012 (JP) 2012-024122

(51) Int. Cl. C08G 18/42; C09D 175/06; H01B 3/30; C08G 18/34

(52) U.S. Cl. CPC C08G 18/4238; C08G 18/348; C09D 175/06; H01B 3/302
USPC 522/39; 525/440.07; 524/602; 522/96

(57) ABSTRACT

Provided is a photocurable moisture-proof insulating coating material which places little burden on the environment and has excellent surface curability with low irradiation. In addition, this photocurable moisture-proof insulating coating material is hydrophobic and exhibits high adhesion to a substrate material. Also provided is a novel urethane (meth)acrylate which is used for this moisture-proof insulating coating material. A urethane (meth)acrylate of the present invention is obtained by reacting (a) a polyester polyol that has a structural unit derived from a hydrogenated dimer acid and a structural unit derived from a hydrogenated dimer diol, (b) a polyisocyanate compound and (c) a hydroxyl group-containing (meth)acrylate. A moisture-proof insulating coating material of the present invention contains this urethane (meth)acrylate and a (meth)acryloyl group-containing compound that does not contain a silicon atom.

### TECHNICAL FIELD

The present invention relates to a novel urethane (meth)acrylate, a moisture-proof insulating coating containing the urethane (meth)acrylate as a preferable component, and an electronic component insulation-processed using the moisture-proof insulating coating.

### BACKGROUND ART

Patent Literature 1 discloses a urethane (meth)acrylate composition obtained by allowing a polyester polyol including a diol having one side chain on a straight chain having 3 to 7 carbon atoms and a dimer acid, a polyisocyanate, and a (meth)acrylate having an active hydrogen to react.

However, Patent Literature 1 does not describe a urethane (meth)acrylate including polyester polyol structural units derived from a hydrogenated dimer diol and a hydrogenated dimer acid.

Patent Literature 2 discloses a urethane (meth)acrylate composition obtained by allowing a polyester polyol including a straight-chain glycol having 2 to 7 carbon atoms and a dimer acid, a polyisocyanate, and a (meth)acrylate having an active hydrogen to react.

However, Patent Literature 2 does not describe a urethane (meth)acrylate including polyester polyol structural units derived from a hydrogenated dimer diol and a hydrogenated dimer acid.

Patent Literature 3 discloses a urethane (meth)acrylate composition obtained by allowing an organic polyisocyanate compound, a polyester polyol containing, as copolymerization components, at least one or more of a dimer acid, a dimer diol, a hydrogenated dimer acid, and a hydrogenated dimer diol and having a number average molecular weight of 8000 or less, and a hydroxyl group-containing (meth)acrylate to react.

However, Patent Literature 3 just describes a urethane (meth)acrylate having polyester polyol structural units derived from diethylene glycol and a dimer acid, and does not describe a urethane (meth)acrylate having polyester polyol structural units derived from a hydrogenated dimer diol and a hydrogenated dimer acid.

Electric appliances have tended to be subjected to downsizing, weight reduction, and multifunctionalization year by year. Packaged circuit boards carried by various electric appliances with controlled downsizing, weight reduction, and multifunctionalization have been insulation-processed for the purpose of being protected from moisture, dust, gas, and the like. For a method of the insulation process, protective coating processing with coatings such as acrylic resins and urethane resins has been widely adopted. Methods of forming coating films of interest by applying such moisture-proof insulating coatings in the state of being dissolved in organic solvents and by drying the coatings have been generally performed.

However, the moisture-proof insulating coatings cause air pollution, since the organic solvents are discharged into atmospheric air when the coatings are painted. In addition, the moisture-proof insulating coatings have a high risk of fire caused by the organic solvents and have large environmental loads.

Many resin compositions that can be cured by irradiation with ultraviolet rays or electron rays have been developed. Various photocurable coatings have already been put to practical use and used for uses in insulation process of packaged circuit boards. As such a resin composition, a urethane-modified acrylate resin composition obtained by allowing a polyester polyol compound, a polyolefin polyol compound, or the like to react with a polyisocyanate and a hydroxyalkyl (meth)acrylate is known.

Patent Literature 4 discloses a photocurable moisture-proof insulating coating containing an acryl-modified hydrogenated polybutadiene resin exhibiting high adhesion to glass and also exhibiting excellent characteristics in a moisture resistance evaluation.

Further, Patent Literature 5 discloses a photocurable moisture-proof insulating coating containing a reaction mixture obtained by allowing 2-hydroxyethylacrylate, a hydrogenated polybutadiene diol, and tolylene diisocyanate to react at a blending ratio of hydroxyl group/isocyanate group>1, isobornyl acrylate, lauryl acrylate, an alkoxysilane compound having an isocyanate group, and a photopolymerization initiator.

Further, Patent Literature 6 discloses a photocurable moisture-proof insulating coating containing a reaction product obtained by allowing 2-hydroxyethylacrylate, a hydrogenated polybutadiene diol, and tolylene diisocyanate to react, lauryl acrylate, bisphenol A propylene glycol adduct diacrylate, and an alkoxysilane compound having an isocyanate group.

However, since the urethane-modified acrylate resin composition employing a polyester polyol compound generally has a high moisture vapor transmission rate, and the urethane-modified acrylate resin composition employing a polyolefin polyol compound has poor adhesion to a substrate material, the reliability of electronic components has been problematic for use of both coatings containing the photocurable resin compositions as moisture-proof insulating coatings for packaged circuit boards.

The resin composition disclosed in Patent Literature 4 has received attention since the resin composition is polymerized even when the concentration of oxygen is high, and the physical properties of the cured product thereof vary, depending on the structure and formulation thereof. However, the viscosity of the resin composition at room temperature is high. Thus, the resin composition has had a handling problem.

The urethane (meth)acrylate compounds disclosed in Patent Literature 5 and Patent Literature 6 have too high viscosities, and there has been a problem in that adjustment to desired viscosity is precluded when large amounts of 2-hydroxyethylacrylate, isobornyl acrylate, and lauryl acrylate, which are monofunctional acrylates, are not used.

### CITATION LIST

### Patent Literature

Patent Literature 1: International Publication No. WO 2009/123236

Patent Literature 2: Japanese Laid-open Patent Publication No. 2010-100711

Patent Literature 3: Japanese Laid-open Patent Publication No. 2008-159437

Patent Literature 4: Japanese Laid-open Patent Publication No. 2001-302946

Patent Literature 5: Japanese Laid-open Patent Publication No. 2008-291114

Patent Literature 6: Japanese Laid-open Patent Publication No. 2008-303362

### SUMMARY OF INVENTION

### Technical Problem

The present invention has been developed with respect to the above problems in the related art. An object of the present invention is to provide a photocurable moisture-proof insulating coating which has a small environmental load and excellent surface curability with low irradiation, is hydrophobic, and exhibits high adhesion to a substrate material.

In addition, an object of the present invention is to provide a novel polymerizable compound which is preferable as a component of the above photocurable moisture-proof insulating coating.

A further object of the present invention is to provide an electronic component which is insulation-processed with the above photocurable moisture-proof insulating coating for a packaged circuit board and has high reliability.

### Solution to Problem

As a result of extensive research conducted in order to solve the above problems, the present inventors found that a novel photocurable composition having a specific structure and containing a polyurethane having a (meth)acryloyl group has good handleability, and a cured product obtained by curing the photocurable composition exhibits high adhesiveness to a base such as glass or polyimide and has excellent electrical insulation characteristics, and the present invention has thus been developed.

More specifically, the present invention (I) relates to a urethane (meth)acrylate obtained by allowing

(a) a polyester polyol having a structural unit derived from a hydrogenated dimer acid and a structural unit derived from a hydrogenated dimer diol;

(b) a polyisocyanate compound; and

(c) a hydroxyl group-containing (meth)acrylate to react.

The present invention (II) relates to a moisture-proof insulating coating including:

(1) the urethane (meth)acrylate of the present invention (1); and

(2) a (meth)acryloyl group-containing compound that does not contain any silicon atom.

The present invention (III) relates to an electronic component insulation-processed using the moisture-proof insulating coating of the present invention (II).

Furthermore, the present invention relates to the following matters [1] to [15]:

[1] A urethane (meth)acrylate obtained by allowing

(a) a polyester polyol having a structural unit derived from a hydrogenated dimer acid and a structural unit derived from a hydrogenated dimer diol;

(b) a polyisocyanate compound; and

(c) a hydroxyl group-containing (meth)acrylate to react.

[2] The urethane (meth)acrylate according to matter [1], wherein the polyester polyol (a) includes not less than 80% by weight of the structural unit derived from the hydrogenated dimer acid based on the total amount of a structural unit derived from a polycarboxylic acid, and not less than 80% by weight of the structural unit derived from the hydrogenated dimer diol, based on the total amount of a structural unit derived from a polyol.

[3] The urethane (meth)acrylate according to matter [1] or [2], wherein the polyisocyanate compound (b) is at least one selected from the group consisting of norbornane diisocyanate, isophorone diisocyanate, and methylene bis(4-cyclohexylisocyanate).

[4] A moisture-proof insulating coating including:

(1) the urethane (meth)acrylate according to any one of matters [1] to [3]; and

(2) a (meth)acryloyl group-containing compound that does not contain any silicon atom.

[5] The moisture-proof insulating coating according to matter [4], further including

(3) a silane coupling agent.

[6] The moisture-proof insulating coating according to matter [4] or [5], further including

(4) a tackifying agent.

[7] The moisture-proof insulating coating according to any one of matters [4] to [6], further including

(5) a photopolymerization initiator.

[8] The moisture-proof insulating coating according to any one of matters [4] to [7], wherein the total amount of a (meth)acryloyl group-containing compound that has a chain aliphatic hydrocarbon group having not less than 9 carbon atoms and does not contain any silicon atom and a liquid (meth)acryloyl group-containing compound that has a cyclic aliphatic hydrocarbon group having not less than 9 carbon atoms and does not contain any silicon atom is not less than 50% by weight based on the total amount of the (meth)acryloyl group-containing compound (2) that does not any silicon atom.

[9] The moisture-proof insulating coating according to any one of matters [6] to [8], wherein the tackifying agent (4) includes a petroleum resin-based tackifying agent.

[10] The moisture-proof insulating coating according to any one of matters [7] to [9], wherein the photopolymerization initiator (5) is a compound represented by Formula (1)

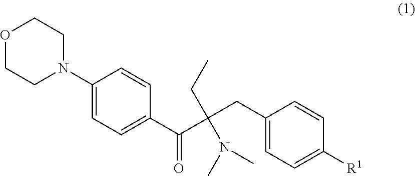

wherein R¹ represents H or CH₃.

[11] The moisture-proof insulating coating according to any one of matters [4] to [10], including 30 to 75% by weight of the (meth)acryloyl group-containing compound (2) that does not contain any silicon atom based on total polymerizable components.

[12] The moisture-proof insulating coating according to any one of matters [5] to [11], including 0.01 to 8 parts by weight of the silane coupling agent (3) based on 100 parts by weight of total polymerizable components.

[13] The moisture-proof insulating coating according to any one of matters [6] to [12], including 0.1 to 35 parts by weight of the tackifying agent (4) based on 100 parts by weight of total polymerizable components.

[14] The moisture-proof insulating coating according to any one of matters [7] to [13], including 0.1 to 10 parts by weight of the photopolymerization initiator (5) based on 100 parts by weight of total polymerizable components.

[15] The moisture-proof insulating coating according to any one of matters [4] to [14], wherein viscosity at 25° C. is 2000 mPa·s or less.

[16] An electronic component insulation-processed using the moisture-proof insulating coating according to any one of matters [4] to [15].

### Advantageous Effects of Invention

The urethane (meth)acrylate of the present invention has the effects wherein the urethane (meth)acrylate is excellent in moisture-proof insulation performance and adhesiveness to a base, the moisture-proof insulating coating in which the urethane (meth)acrylate is used has a small environmental load and exhibits high adhesion to a substrate material although the moisture-proof insulating coating is an urethane-modified (meth)acrylate resin composition having a low moisture vapor transmission rate, and an electronic component with high reliability can be manufactured by applying and curing the moisture-proof insulating coating.

### BRIEF DESCRIPTION OF DRAWINGS

FIG. 1 represents the 1H-NMR spectrum (solvent: CDCl₃) of the urethane acrylate B obtained in Synthesis Example 2.

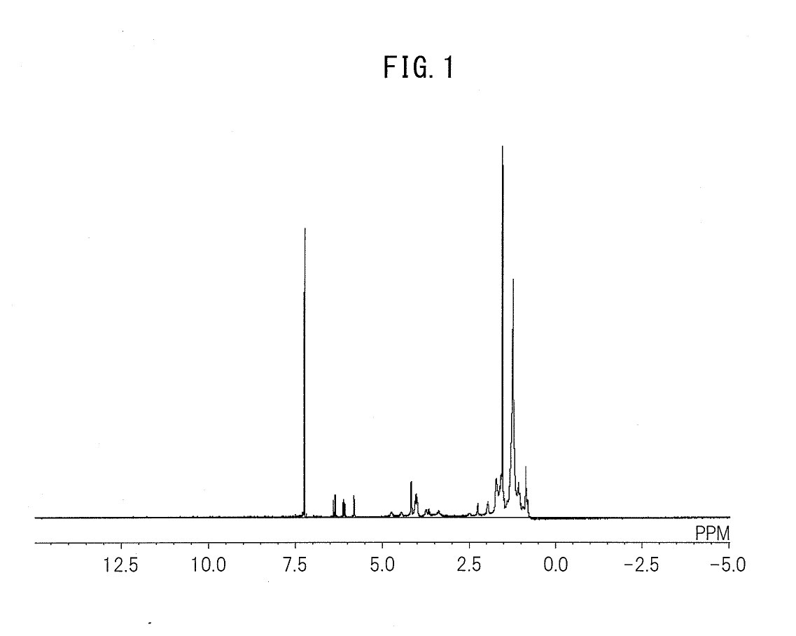

FIG. 2 represents the IR spectrum of the urethane acrylate B obtained in Synthesis Example 2.

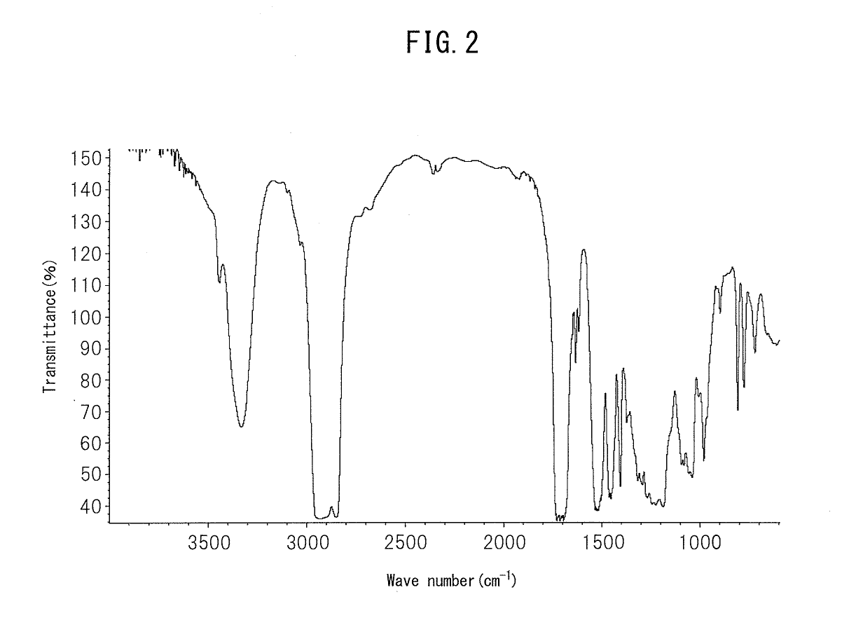

FIG. 3 represents the 1H-NMR spectrum (solvent: CDCl₃) of the urethane acrylate C obtained in Synthesis Example 3.

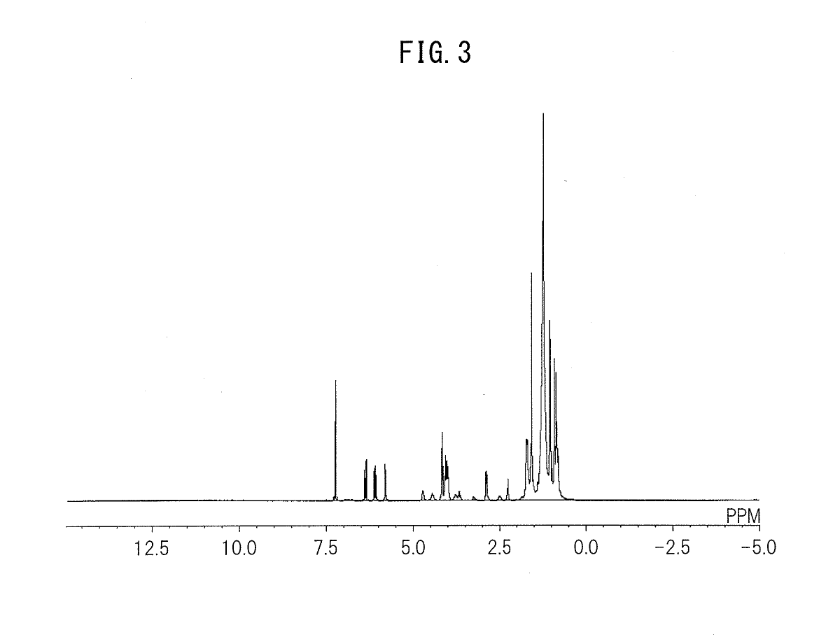

FIG. 4 represents the IR spectrum of the urethane acrylate C obtained in Synthesis Example 3.

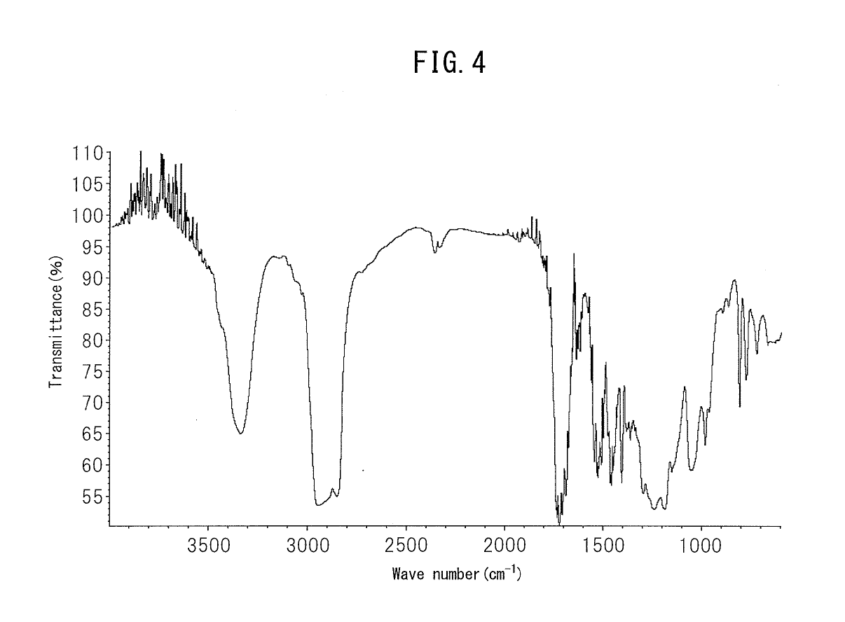

FIG. 5 represents the 1H-NMR spectrum (solvent: CDCl₃) of the urethane acrylate D obtained in Synthesis Example 4.

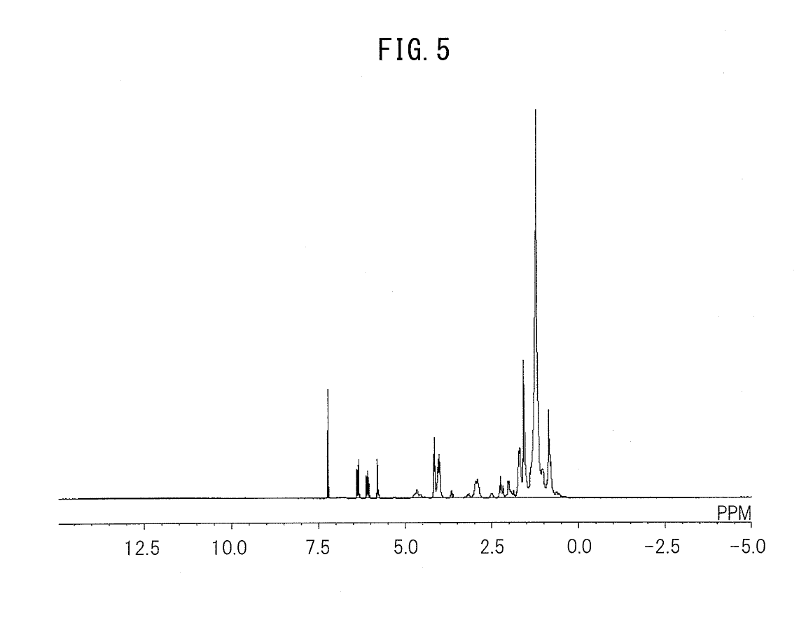

FIG. 6 represents the IR spectrum of the urethane acrylate D obtained in Synthesis Example 4.

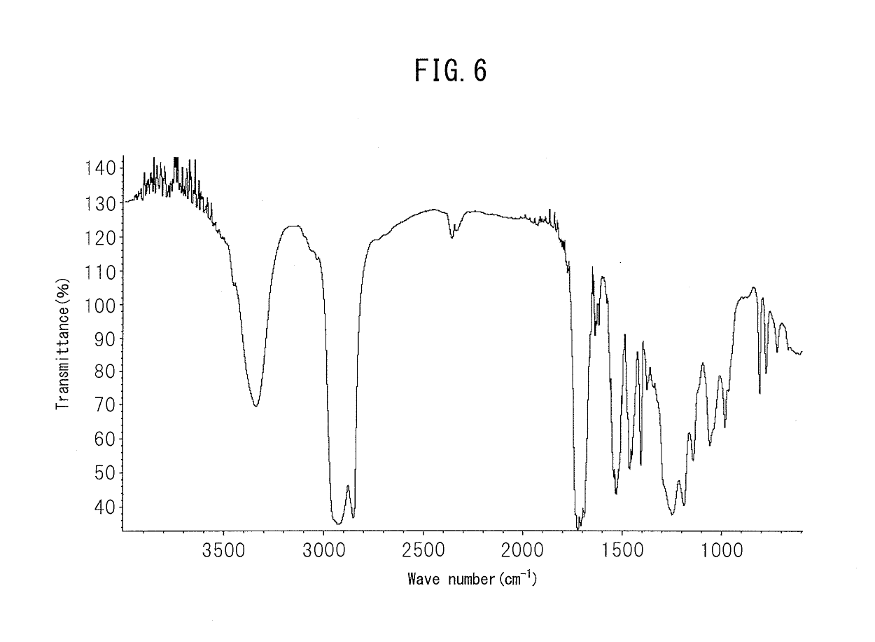

### DESCRIPTION OF EMBODIMENTS

The present invention will be specifically explained below.

As used herein, the term “(meth)acryloyl group” means an acryloyl group and/or a methacryloyl group.

First, the present invention (I) will be explained.

The present invention (I) is a urethane (meth)acrylate obtained by allowing the following components (a) to (c) to react.

Component (a): polyester polyol having a structural unit derived from a hydrogenated dimer acid and a structural unit derived from a hydrogenated dimer diol

Component (b): polyisocyanate compound

Component (c): hydroxyl group-containing (meth)acrylate

First, the component (a) which is a preferable raw material component of the urethane (meth)acrylate of the present invention (I) will be explained.

The component (a) which is the preferable raw material component of the urethane (meth)acrylate of the present invention (I) is a polyester polyol having a structural unit derived from a hydrogenated dimer acid and a structural unit derived from a hydrogenated dimer diol.

The term “dimer acid” refers to a dimer acid obtained by allowing a fatty acid having two to four ethylenic double bonds and 14 to 22 carbon atoms (hereinafter referred to as an “unsaturated fatty acid A”), preferably a fatty acid having two ethylenic double bonds and 14 to 22 carbon atoms, and a fatty acid having one to four ethylenic double bonds and 14 to 22 carbon atoms (hereinafter referred to as an “unsaturated fatty acid B”), preferably a fatty acid having one or two ethylenic double bonds and 14 to 22 carbon atoms, to react on double bonds. Examples of the above unsaturated fatty acid A include tetradecadienoic acids, hexadecadienoic acids, octadecadienoic acids (such as linoleic acid), eicosadienoic acids, docosadienoic acids, octadecatrienoic acids (such as linolenic acid), and eicosatetraenoic acids (such as arachidonic acid), most preferably linoleic acid. Examples of the unsaturated fatty acid B include the above examples as well as tetradecenoic acids (tsuzuic acid, physeteric acid, myristoleic acid), hexadecenoic acids (such as palmitoleic acid), octadecenoic acids (such as oleic acid, elaidic acid, and vaccenic acid), eicosenoic acids (such as gadoleic acid), and docosenoic acids (such as erucic acid, setoleic acid, and brassidic acid) as fatty acids having one ethylenic double bond and 14 to 22 carbon atoms, most preferably oleic acid or linoleic acid.

In the dimerization reaction described above, a use ratio (molar ratio) between the unsaturated fatty acid A and the unsaturated fatty acid B is preferably around 1:1.2 to 1.2:1, most preferably 1:1. The dimerization reaction described above can be conducted according to a known method, e.g., a method described in Japanese Laid-open Patent Publication No. 9-136861. In other words, the dimerization reaction can be conducted, for example, by adding 1 to 20 parts by weight, preferably 2 to 8 parts by weight, of a Lewis acid- or Broensted acid-type liquid or a solid catalyst, preferably a montmorillonite-based activated clay, based on a total amount of the unsaturated fatty acid A and the unsaturated fatty acid B of 100 parts by weight, to the unsaturated fatty acid A and the unsaturated fatty acid B, and heating the resultant at 200 to 270° C., preferably 220 to 250° C. For pressure during the reaction, the reaction is generally conducted in the state of slight pressurization, and the pressure may be normal pressure. Reaction time is generally 5 to 7 hours, although the reaction time varies according to a catalyst amount and reaction temperature. After finishing the reaction, the catalyst is filtered off, distillation is then conducted under reduced pressure to distil off any unreacted raw material and isomerized fatty acids, and a dimer acid fraction can be obtained thereafter by distillation. It is considered that the dimerization reaction described above proceeds through double bond migration (isomerization) and a Diels-Alder reaction. However, the present invention is not limited to this consideration.

The obtained dimer acid is generally a mixture of dimer acids the structures of which differ according to the binding site or isomerization of a double bond. The dimer acid may be used separately or may be used without being processed. Further, the obtained dimer acid may contain a small amount of monomer acid (e.g., not more than 6% by weight; in particular, not more than 4% by weight) or polymer acid or the like the degree of polymerization of which is not less than the degree of polymerization of a trimer acid (e.g., not more than 6% by weight; in particular, not more than 4% by weight).

As used herein, the term “hydrogenated dimer acid” refers to a saturated dicarboxylic acid obtained by hydrogenating the carbon-carbon double bond of the dimer acid described above.

For example, when a dimer acid having 36 carbon atoms produced with linoleic acid and linoleic acid or oleic acid as the dimer acid described above is used as a raw material, the structure of the main component of the hydrogenated dimer acid is a structure represented by the following Formula (2) and Formula (3):

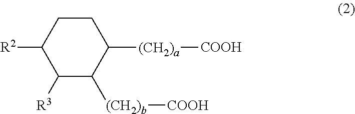

wherein both R² and R³ are alkyl groups, and the total of the respective numbers of carbon atoms contained in R² and R³, a, and b is 28 (i.e., the number of carbon atoms contained in R²+the number of carbon atoms contained in R³+a+b=28); and

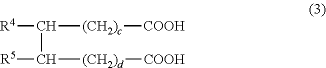

wherein both R⁴ and R⁵ are alkyl groups, and the total of the respective numbers of carbon atoms contained in R⁴ and R⁵, c, and d is 32 (i.e., the number of carbon atoms contained in R⁴+the number of carbon atoms contained in R⁵+c+d=32).

Examples of commercially available products of hydrogenated dimer acids include PRIPOL® 1009 and the like (manufactured by Croda), EMPOL® 1008, and EMPOL® 1062 (manufactured by BASF AG).

The “hydrogenated dimer diol” described herein is a hydrogenated dimer diol in which a carboxylic acid or carboxylate moiety of a dimer acid is converted to an alcohol by reducing at least one of the dimer acid described above, the hydrogenated dimer acid described above, and lower alcohol esters thereof in the presence of a catalyst, and for a raw material, a diol of which a double bond is hydrogenated when having a carbon-carbon double bond, is contained as a main component.

For example, when a hydrogenated dimer diol is produced by reducing a hydrogenated dimer acid containing, as a main component, a compound having a structure represented by Formula (2) and Formula (3), the structure of the main component of the hydrogenated dimer diol is a structure represented by the following Formula (4) and Formula (5):

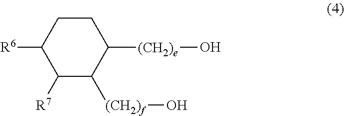

wherein both R⁶ and R⁷ are alkyl groups, and the total of the respective numbers of carbon atoms contained in R⁶ and R⁷, e, and f is 30 (i.e., the number of carbon atoms contained in R⁶+the number of carbon atoms contained in R⁷+e+f=30); and

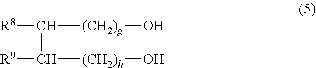

wherein both R⁸ and R⁹ are alkyl groups, and the total of the respective numbers of carbon atoms contained in R⁸ and R⁹, g, and h is 34 (i.e., the number of carbon atoms contained in R⁸+the number of carbon atoms contained in R⁹+g+h=34).

Examples of commercially available products of hydrogenated dimer diols include PRIPOL® 2033 and the like (manufactured by Croda), and Sovermol® 908 (manufactured by BASF AG).

The component (a) which is a preferable raw material component of the urethane (meth)acrylate of the present invention (I) can be produced by conducting a condensation reaction of an acid component containing the hydrogenated dimer acid as a preferable component with a polyol component containing the hydrogenated dimer diol as a preferable component in the presence of an esterification catalyst.

The above esterification reaction is generally conducted at a reaction temperature of around 150 to 250° C., since water is removed. The reaction is generally conducted under a condition of normal pressure or reduced pressure as pressure during the reaction.

The component (a) which is a preferable raw material component of the urethane (meth)acrylate of the present invention (I) can also be produced by conducting a transesterification reaction of a lower alkyl ester of an acid containing the hydrogenated dimer acid as a preferable component with a polyol component containing the hydrogenated dimer diol as a preferable component in the presence of a transesterification catalyst.

The above transesterification reaction is generally conducted at a reaction temperature of around 120 to 230° C., since alcohol is removed. The reaction is generally conducted under a condition of normal pressure or reduced pressure as pressure during the reaction.

As long as physical properties are not deteriorated, an acid other than the hydrogenated dimer acid can also be used as a raw material of the polyester polyol, if necessary. However, it is preferable to use not less than 80% by weight of the hydrogenated dimer acid, and it is more preferable to use not less than 90% by weight of the hydrogenated dimer acid, based on the total amount of acid components as the raw materials of the polyester polyol.

As long as physical properties are not deteriorated, a polyol other than the hydrogenated dimer diol can also be used as a raw material of the polyester polyol, if necessary. However, it is preferable to use not less than 80% by weight of the hydrogenated dimer diol, and it is more preferable to use not less than 90% by weight of the hydrogenated dimer diol, based on the total amount of polyol components as the raw materials of the polyester polyol.

It is defined that when a hydrogenated dimer diol which is a raw material of the component (a) remains in production of the component (a), the hydrogenated dimer diol is not contained in the component (a).

In other words, it is meant that when 8% by weight of a hydrogenated dimer diol remains in a polyester polyol including a hydrogenated dimer diol and a hydrogenated dimer acid, the hydrogenated dimer diol is not contained in the component (a).

It is defined that when a dimer diol other than the hydrogenated dimer diol contained in the component (a) is newly added to produce the urethane (meth)acrylate of the present invention (I), the added dimer diol is not also contained in the component (a).

In other words, it is meant that when a hydrogenated dimer diol which is 8 parts by weight of a raw material remains in 100 parts by weight of a synthetic product in synthesis of the component (a) and 5 parts by weight of a hydrogenated dimer diol is added to produce the urethane (meth)acrylate of the present invention (I), neither the hydrogenated dimer diol as the raw material remaining in the synthesis of the component (a) nor the thereafter added hydrogenated dimer diol is contained in the component (a).

A polyol other than the component (a) (i.e., the polyester polyol having the structural unit derived from the hydrogenated dimer acid and the structural unit derived from the hydrogenated dimer diol) can be used in the urethane (meth)acrylate of the present invention (I) as long as physical properties are not deteriorated. Examples of such polyols other than the component (a) include hydrogenated dimer diols (chain hydrogenated dimer diols); chain aliphatic polyols other than dimer diols such as 1,3-propanediol, 1,4-butanediol, 1,3-butanediol, 1,5-pentanediol, neopentyl glycol, 3-methyl-1,5-pentanediol, 1,6-hexanediol, 2-methyl-1,8-octanediol, 1,9-nonanediol, 2-ethyl-2-butyl-1,3-propanediol, 2,4-diethyl-1,5-pentanediol, 1,10-decanediol, and 1,12-dodecanediol; hydrogenated dimer diols (having alicyclic structures); polyols having alicyclic structures other than dimer diols such as 1,4-cyclohexanedimethanol, 1,3-cyclohexanedimethanol, tricyclo[5.2.1.0^{2,6}]decanedimethanol, and 2-methylcyclohexane-1,1-dimethanol; polyols having aromatic rings such as trimmer triol, p-xylylene glycol, bisphenol A ethylene oxide adduct, bisphenol F ethylene oxide adduct, and biphenol ethylene oxide adduct; polyether polyols such as polyethylene glycol, polypropylene glycol, and polytetramethylene glycol; polyester polyols such as polyhexamethylene adipate, polyhexamethylene succinate, and polycaprolactone; and (poly)carbonate diols such as α,ω-poly(1,6-hexylenecarbonate)diol, α,ω-poly(3-methyl-1,5-pentylenecarbonate)diol, α,ω-poly[(1,6-hexylene:3-methyl-pentamethylene)carbonate]diol, and α,ω-poly[(1,9-nonylene:2-methyl-1,8-octylene)carbonate]diol, and include, as commercially available products, PLACCEL, CD-205, 205PL, 205HL, 210, 210PL, 210HL, 220, 220PL, 220HL (trade names) manufactured by DAICEL CHEMICAL INDUSTRIES, LTD., and KURARAY POLYOL C-590, C-1065N, C-1015N, C-2015N (trade names) manufactured by KURARAY CO., LTD.

Of these, polyols preferred for highly maintaining electrical insulation performance and for comparatively lowly maintaining viscosity are hydrogenated dimer diols (chain hydrogenated dimer diols); chain aliphatic diols having 9 or more carbon atoms other than dimer diols such as 2-methyl-1,8-octanediol, 1,9-nonanediol, 2-ethyl-2-butyl-1,3-propanediol, 2,4-diethyl-1,5-pentanediol, 1,10-decanediol, and 1,12-dodecanediol; hydrogenated dimer diols (having alicyclic structures); and (poly)carbonate diols having structural units derived from chain aliphatic polyols having 6 or more carbon atoms of (poly)carbonate diols such as α,ω-poly(1,6-hexylenecarbonate)diol, α,ω-poly(3-methyl-1,5-pentylenecarbonate)diol, α,ω-poly[(1,6-hexylene:3-methyl-pentamethylene)carbonate]diol, and α,ω-poly[(1,9-nonylene:2-methyl-1,8-octylene)carbonate]diol.

The expression “(poly)carbonate” of a (poly) carbonate diol as used herein means that the (poly) carbonate diol has one or more carbonate bonds in the molecule. Accordingly, the term “(poly)carbonate diol” means a compound having one or more carbonate bonds and two alcoholic hydroxyl groups in the molecule.

The component (b) which is a preferable raw material component of the urethane (meth)acrylate of the present invention (I) will be explained below.

The component (b) which is a preferable raw material component of the urethane (meth)acrylate of the present invention (I) is a polyisocyanate compound.

The component (b) is a compound having two or more isocyanato groups (—NCO). Specific examples thereof include 1,4-cyclohexane diisocyanate, isophorone diisocyanate, methylenebis(4-cyclohexylisocyanate), 1,3-bis(isocyanatomethyl)cyclohexane, 1,4-bis(isocyanatomethyl)cyclohexane, 2,4-tolylene diisocyanate, 2,6-tolylene diisocyanate, diphenylmethane-4,4′-diisocyanate, 1,3-xylylene diisocyanate, 1,4-xylylene diisocyanate, lysine triisocyanate, lysine diisocyanate, hexamethylene diisocyanate, 2,4,4-trimethylhexamethylene diisocyanate, 2,2,4-trimethylhexanemethylene diisocyanate, and norbornane diisocyanate, which may be used singly or in combination of two or more kinds thereof.

For highly maintaining moisture-proof performance, 1,4-cyclohexane diisocyanate, isophorone diisocyanate, methylenebis(4-cyclohexylisocyanate), 1,3-bis(isocyanatomethyl)cyclohexane, 1,4-bis(isocyanatomethyl)cyclohexane, diphenylmethane-4,4′-diisocyanate, 1,3-xylylene diisocyanate, 1,4-xylylene diisocyanate, 2,4,4-trimethylhexamethylene diisocyanate, 2,2,4-trimethylhexanemethylene diisocyanate, and norbornane diisocyanate are preferred, and methylenebis(4-cyclohexylisocyanate), isophorone diisocyanate, and norbornane diisocyanate are further preferred. In consideration of reactivity, norbornane diisocyanate is most preferred. When importance is attached to moisture-proof insulation performance, methylenebis(4-cyclohexylisocyanate) is most preferred.

The component (c) which is a preferable raw material component of the urethane (meth)acrylate of the present invention (I) will be explained below.

The component (c) which is a preferable raw material component of the urethane (meth)acrylate of the present invention (I) is a hydroxyl group-containing (meth)acrylate. The “hydroxyl group-containing (meth)acrylate” is not particularly limited as long as the hydroxyl group-containing (meth)acrylate is a (meth)acrylate having a hydroxyl group in the molecule. Specific examples thereof include 2-hydroxyethylacrylate, 2-hydroxypropylacrylate, 3-hydroxypropylacrylate, 2-hydroxybutylacrylate, 4-hydroxybutylacrylate, 2-hydroxy-3-phenoxypropylacrylate, 2-hydroxy-3-(o-phenylphenoxy)propylacrylate, 2-hydroxymethylacrylamide, 2-hydroxyethylmethacrylate, 2-hydroxypropylmethacrylate, 3-hydroxypropylmethacrylate, 2-hydroxybutylmethacrylate, 4-hydroxybutylmethacrylate, 2-hydroxy-3-phenoxypropylmethacrylate, and 2-hydroxy-3-(o-phenylphenoxy)propylmethacrylate.

Of these, 2-hydroxyethylacrylate, 2-hydroxypropylacrylate, 3-hydroxypropylacrylate, 2-hydroxybutylacrylate, 4-hydroxybutylacrylate, 2-hydroxy-3-phenoxypropylacrylate, and 2-hydroxy-3-(o-phenylphenoxy)propylacrylate are preferred in consideration of the curing rate of the urethane (meth)acrylate of the present invention (I). In consideration of reactivity with an isocyanate group, 2-hydroxyethylacrylate, 3-hydroxypropylacrylate, and 4-hydroxybutylacrylate are preferred, and 4-hydroxybutylacrylate is most preferred.

In the method for producing the urethane (meth)acrylate of the present invention (I), synthesis is enabled by allowing a polyester polyol containing a hydrogenated dimer acid and a hydrogenated dimer diol as copolymer components, a polyisocyanate compound, and a hydroxyl group-containing (meth)acrylate to react in the presence or absence of a known urethanization catalyst such as dibutyltin dilaurate or dioctyltin dilaurate. The reaction in the presence of the catalyst is preferable in view of shortening reaction time. However, since the physical property values of a cured film during actual use can be finally adversely affected by using a large amount of catalyst, the amount of the catalyst used is preferably 0.001 to 1 part by weight based on a total amount of the polyester polyol containing the hydrogenated dimer acid and the hydrogenated dimer diol as copolymer components, the polyisocyanate compound, and the hydroxyl group-containing (meth)acrylate, of 100 parts by weight.

The urethanization catalyst catalyzes the hydrolysis reaction of an alkoxysilyl group when the alkoxysilyl group is included in the moisture-proof insulating coating of the present invention (II) mentioned below. In such a case, it is preferable to consider the balance between the temporal stability of the moisture-proof insulating coating of the present invention (II) mentioned below and the adhesiveness thereof to a substrate, and the amount of the catalyst used in the case is preferably 0.003 to 0.2 part by weight, still more preferably 0.005 to 0.15 part by weight, based on a total amount of a polyol component containing a polyester polyol having a structural unit derived from a hydrogenated dimer acid and a structural unit derived from a hydrogenated dimer diol, a polyisocyanate compound, and a hydroxyl group-containing (meth)acrylate, of 100 parts by weight. In the case of less than 0.001 part by weight, the addition effect of the catalyst is inhibited from being exhibited. When more than 1 part by weight of the catalyst is used, the physical property values of a cured film during actual use may be finally adversely affected as mentioned above.

The order of putting the raw materials is not particularly limited. In general, the polyisocyanate compound and, if necessary, the urethanization catalyst are charged into a reactor and stirred, the polyester polyol having the structural unit derived from the hydrogenated dimer acid and the structural unit derived from the hydrogenated dimer diol, and, if necessary, the polyol components other than the polyester polyol are then sequentially charged at a temperature in the reactor of 50° C. to 140° C., preferably 60° C. to 120° C., and the components are then allowed to react at a temperature in the reactor of 50° C. to 160° C., preferably 60° C. to 140° C. Then, a polymerization inhibitor and, if necessary, the urethanization catalyst are added at a temperature in the reactor of 30° C. to 120° C., preferably 50° C. to 100° C., and the hydroxyl group-containing (meth)acrylate is charged by dropwise addition. The temperature in the reactor is preferably maintained at 30° C. to 120° C., desirably 50° C. to 100° C., during the dropwise addition. After finishing the dropwise addition, the temperature in the reactor is maintained at 30° C. to 120° C., desirably 50° C. to 100° C., and the reaction is finished.

The molar ratio of put raw materials (i.e., (the number of hydroxyl groups in a polyester polyol having a structural unit derived from a hydrogenated dimer acid and a structural unit derived from a hydrogenated dimer diol and the polyol components other than the polyester polyol)/(the number of isocyanate groups in a polyisocyanate compound)/(the number of hydroxyl groups in a hydroxyl group-containing (meth)acrylate)) is regulated according to the molecular weight of the polyurethane of interest. However, it is preferable that the number of the isocyanate groups in the polyisocyanate compound is greater than the number of the hydroxyl groups in the polyester polyol having the structural unit derived from the hydrogenated dimer acid and the structural unit derived from the hydrogenated dimer diol and the polyol components other than the polyester polyol.

When the ratio of the total number of the hydroxyl groups in the polyester polyol having the structural unit derived from the hydrogenated dimer acid and the structural unit derived from the hydrogenated dimer diol and the polyol components other than the polyester polyol to the number of the isocyanate groups in the polyisocyanate compound is almost 1.0, the molecular weight is increased. When the ratio deviates from and is less than 1.0, the molecular weight is decreased.

The molar ratio of the put raw materials is not particularly limited, and the ratio of the number of the isocyanate groups in the polyisocyanate compound to the total number of the hydroxyl groups in the polyester polyol having the structural unit derived from the hydrogenated dimer acid and the structural unit derived from the hydrogenated dimer diol and the polyol components other than the polyester polyol is preferably in a range of 4:1 to 1.5:1.

The ratio of more than 4:1 may result in the decreased abundance ratio of the structural unit derived from the hydrogenated dimer acid or the structural unit of the hydrogenated dimer diol and may cause unfavorable moisture-proof properties or unfavorable electrical insulation reliability. In addition, the ratio of less than 1.4:1 may result in the very great molecular weight, and in very high viscosity when the moisture-proof insulating coating of the present invention (II) mentioned below is used.

An acryloyl group-containing urethane compound having neither a structural unit derived from a hydrogenated dimer acid nor a structural unit derived from a hydrogenated dimer diol is also produced when the urethane (meth)acrylate of the present invention (I) is synthesized, and it is defined in the present specification that the acryloyl group-containing urethane compound having neither a structural unit derived from a hydrogenated dimer acid nor a structural unit derived from a hydrogenated dimer diol is not contained in the urethane (meth)acrylate of the present invention (I). For example, when a polyester polyol having a structural unit derived from a hydrogenated dimer acid and a structural unit derived from a hydrogenated dimer diol, 1,3-bis(isocyanatomethyl)cyclohexane as an organic polyisocyanate compound, and 2-hydroxyethylacrylate as a hydroxyl group-containing (meth)acrylate are used as raw materials for producing the urethane (meth)acrylate of the present invention (I) to produce the urethane (meth)acrylate of the present invention (I), a compound of Formula (6), which is an acryloyl group-containing urethane compound that does not have any structural unit derived from a hydrogenated dimer diol, is also produced.

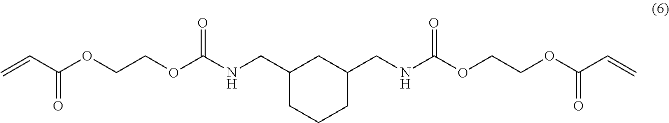

However, it is meant in the present specification that the compound of Formula (6) is not included in the urethane (meth)acrylate of the present invention (I) since the compound of Formula (6) does not have the structural unit derived from the hydrogenated dimer acid and the structural unit derived from the hydrogenated dimer diol.

The moisture-proof insulating coating of the present invention (II) will be explained below.

The present invention (II) is a moisture-proof insulating coating containing, as preferable components, the following component (1) and component (2):

component (1): urethane (meth)acrylate of the present invention (1); and

component (2): (meth)acryloyl group-containing compound that does not contain any silicon atom.

The component (1) of the moisture-proof insulating coating of the present invention (II) is the above-mentioned urethane (meth)acrylate of the present invention (1).

The component (2) of the moisture-proof insulating coating of the present invention (II) will be explained below.

The component (2) is a (meth)acryloyl group-containing compound that does not contain any silicon atom in the structural formula, is preferably liquid at ordinary temperature, and preferably has a viscosity of 1 Pa·s or less at 25° C. in view of improvement in dispersibility in the moisture-proof insulating coating and easiness of coating of the moisture-proof insulating coating. The (meth)acryloyl group-containing compound that does not contain any silicon atom means that the (meth)acryloyl group-containing compound does not contain any silane coupling agent which is a component (3) mentioned below.

Examples of the component (2) include the following compounds.

Examples thereof include (meth)acryloyl group-containing compounds having cyclic ether groups such as glycidyl acrylate, tetrahydrofurfuryl acrylate, glycidyl methacrylate, and tetrahydrofurfuryl methacrylate; monofunctional (meth)acryloyl group-containing compound having cyclic aliphatic groups such as cyclohexyl acrylate, isobornyl acrylate, dicyclopentenyl acrylate, dicyclopentenyloxyethyl acrylate, dicyclopentanyl acrylate, dicyclopentanylethyl acrylate, 4-tert-butylcyclohexylacrylate, cyclohexyl methacrylate, isobornyl methacrylate, dicyclopentenyl methacrylate, dicyclopentenyloxyethyl methacrylate, dicyclopentanyl methacrylate, dicyclopentanylethyl methacrylate, and 4-tert-butylcyclohexylmethacrylate; monofunctional (meth)acryloyl group-containing compounds having chain aliphatic groups such as lauryl acrylate, isononyl acrylate, 2-ethylhexylacrylate, isobutyl acrylate, tert-butylacrylate, isooctyl acrylate, isoamyl acrylate, lauryl methacrylate, isononyl methacrylate, 2-ethylhexylmethacrylate, isobutyl methacrylate, tert-butylmethacrylate, isooctyl methacrylate, and isoamyl methacrylate; and monofunctional (meth)acryloyl group-containing compounds having aromatic rings such as benzyl acrylate, phenoxyethyl acrylate, benzyl methacrylate, phenoxyethyl methacrylate, and 2-hydroxy-3-phenoxypropylmethacrylate.

Of the monofunctional (meth)acryloyl group-containing compounds, preferred are monofunctional (meth)acryloyl group-containing compounds having cyclic aliphatic groups such as cyclohexyl acrylate, isobornyl acrylate, dicyclopentenyl acrylate, dicyclopentenyloxyethyl acrylate, dicyclopentanyl acrylate, dicyclopentanyloxyethyl acrylate, cyclohexyl methacrylate, isobornyl methacrylate, dicyclopentenyl methacrylate, dicyclopentenyloxyethyl methacrylate, dicyclopentanyl methacrylate, and dicyclopentanylethyl methacrylate; and monofunctional (meth)acryloyl group-containing compounds having chain aliphatic groups such as lauryl acrylate, isononyl acrylate, 2-ethylhexylacrylate, isobutyl acrylate, tert-butylacrylate, isooctyl acrylate, isoamyl acrylate, lauryl methacrylate, isononyl methacrylate, 2-ethylhexylmethacrylate, isobutyl methacrylate, tert-butylmethacrylate, isooctyl methacrylate, and isoamyl methacrylate, and further preferred are isobornyl acrylate, dicyclopentanyl acrylate, dicyclopentanyloxyethyl acrylate, lauryl acrylate, isononyl acrylate, 2-ethylhexylacrylate, and isooctyl acrylate.

The content of the component (1) in the moisture-proof insulating coating of the present invention (II) is preferably 25 to 70% by weight, more preferably 30 to 60% by weight, still more preferably 30 to 55% by weight, based on the total polymerizable components. The content of the component (1) of less than 25% by weight based on the total polymerizable components may result in deterioration of the moisture-proof performance of the photocurable moisture-proof insulating coating and is not preferable. In addition, the content of the component (1) of more than 70% by weight based on the total polymerizable components results in the very high viscosity of the photocurable moisture-proof insulating coating and is not preferable in view of handling.

The content of the component (2) in the moisture-proof insulating coating of the present invention (II) is preferably 30 to 75% by weight, more preferably 40 to 70% by weight, still more preferably 45 to 70% by weight, based on the total polymerizable components. The content of the component (2) of more than 75% by weight based on the total polymerizable components may result in deterioration of the moisture-proof performance of the photocurable moisture-proof insulating coating and is not preferable. In addition, the content of the component (2) of less than 30% by weight based on the total polymerizable components results in the very high viscosity of the photocurable moisture-proof insulating coating and is not preferable in view of handling.

The total amount of a (meth)acryloyl group-containing compound that has a chain aliphatic hydrocarbon group having 9 or more carbon atoms and does not have any silicon atom, such as lauryl acrylate, isononyl acrylate, lauryl methacrylate, or isononyl methacrylate, and a (meth)acryloyl group-containing compound that has a cyclic aliphatic hydrocarbon group having 9 or more carbon atoms and does not have any silicon atom, such as isobornyl acrylate, dicyclopentenyl acrylate, dicyclopentenyloxyethyl acrylate, dicyclopentanyl acrylate, dicyclopentanylethyl acrylate, 4-tert-butylcyclohexylacrylate, isobornyl methacrylate, dicyclopentenyl methacrylate, dicyclopentenyloxyethyl methacrylate, dicyclopentanyl methacrylate, dicyclopentanylethyl methacrylate, or 4-tert-butylcyclohexylmethacrylate is preferably not less than 50% by weight based on the total amount of the component (2).

A polymerization inhibitor may be added to the moisture-proof insulating coating of the present invention (II) in order to enhance storage stability, and the addition is preferable.

Examples of the polymerization inhibitor include, but are not particularly limited to, hydroquinone, p-methoxyphenol, p-benzoquinone, naphthoquinone, phenanthraquinone, toluquinone, 2,5-diacetoxy-p-benzoquinone, 2,5-dicaproxy-p-benzoquinone, 2,5-acyloxy-p-benzoquinone, 2,5-di-tert-butyl-3-methylphenol, p-t-butylcatechol, 2,5-di-t-butylhydroquinone, p-tert-butylcatechol, mono-t-butylhydroquinone, 2,5-di-t-amylhydroquinone, di-t-butyl-para-cresol hydroquinone monomethyl ether, alpha-naphthol, acetamidine acetate, acetamidine sulfate, phenylhydrazine hydrochloride, hydrazine hydrochloride, trimethylbenzylammonium chloride, laurylpyridinium chloride, cetyltrimethylammonium chloride, phenyltrimethylammonium chloride, trimethylbenzylammonium oxalate, di(trimethylbenzylammonium)oxalate, trimethylbenzylammonium malate, trimethylbenzylammonium tartrate, trimethylbenzylammonium glycolate, phenyl-β-naphthylamine, parabenzylaminophenol, di-β-naphthylparaphenylenediamine, dinitrobenzene, trinitrotoluene, picric acid, cyclohexanone oxime, pyrogallol, tannic acid, resorcin, triethylamine hydrochloride, dimethylaniline hydrochloride, and dibutylamine hydrochloride.

These may be used singly or in appropriate combination of two or more kinds thereof. Of these, hydroquinone, p-methoxyphenol, p-benzoquinone, naphthoquinone, phenanthraquinone, toluquinone, 2,5-diacetoxy-p-benzoquinone, 2,5-dicaproxy-p-benzoquinone, 2,5-acyloxy-p-benzoquinone, p-t-butylcatechol, 2,5-di-t-butylhydroquinone, p-tert-butylcatechol, mono-t-butylhydroquinone, 2,5-di-t-amylhydroquinone, di-t-butyl-para-cresol hydroquinone monomethyl ether, and phenothiazine are preferably used.

In general, it is preferable to add 0.01 to 10 parts by weight of the polymerization inhibitor based on 100 parts by weight of the total polymerizable components.

As used herein, the term “polymerizable component” means a compound that can be polymerized by radical polymerization, and the term “total polymerizable components” means the total amount of polymerizable components. Both of the component (1) and the component (2) are included in the polymerizable components. It is meant that a silane coupling agent having a radical polymerizable unsaturated group, which is p-styryltrimethoxysilane, p-styryltriethoxysilane, 3-acryloyloxypropyltrimethoxysilane, 3-methacryloyloxypropyltrimethoxysilane, 3-acryloyloxypropyltriethoxysilane, 3-methacryloyloxypropyltriethoxysilane, 3-acryloyloxypropylmethyldimethoxysilane, 3-methacryloyloxypropylmethyldimethoxysilane, 3-acryloyloxypropylmethyldiethoxysilane, or 3-methacryloyloxypropylmethyldiethoxysilane in the component (3) mentioned below, is also included in the polymerizable components.

The moisture-proof insulating coating of the present invention (II) can further contain a silane coupling agent (hereinafter referred to as “component (3)”) for the purpose of imparting adhesiveness to glass, a metal, or a metal oxide.

The component (3) an organosilicon compound having both of a functional group reaction-bound to an organic material and a functional group reaction-bound to an inorganic material in the molecule, and the structure thereof is generally represented as Formula (7).

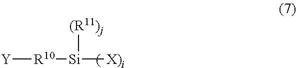

In the formula, Y is a functional group reaction-bound to an organic material. Typical examples thereof include vinyl group, epoxy group, amino group, substituted amino group, (meth)acryloyl group, and mercapto group. X is a functional group that reacts with an inorganic material, and is hydrolyzed by water or moisture to generate a silanol. The silanol is reaction-bound to an inorganic material. Typical examples of X include alkoxy group, acetoxy group, and chloro atom. R¹⁰ is a divalent organic group, and R¹¹ represents an alkyl group. In addition, i represents an integer of 1 to 3, and j represents an integer of 0 to 2. However, i+j=3 is satisfied.

Examples of the silane coupling agent include 3-isocyanatepropyltriethoxysilane, 3-isocyanatepropyl trimethoxysilane, 3-isocyanatepropylmethyldiethoxysilane, 3-isocyanatepropylmethyldimethoxysilane, p-styryltrimethoxysilane, p-styryltriethoxysilane, vinyltrimethoxysilane, vinyltriethoxysilane, vinyltriisopropoxysilane, vinyltris(2-methoxyethoxy)silane, 3-acryloyloxypropyltrimethoxysilane, 3-methacryloyloxypropyltrimethoxysilane, 3-acryloyloxypropyltriethoxysilane, 3-methacryloyloxypropyltriethoxysilane, 3-acryloyloxypropylmethyldimethoxysilane, 3-methacryloyloxypropylmethyldimethoxysilane, 3-acryloyloxypropylmethyldiethoxysilane, 3-methacryloyloxypropylmethyldiethoxysilane, 2-(3,4-epoxycyclohexyl)ethyltrimethoxysilane, 3-glycidoxypropyltrimethoxysilane, 3-glycidoxypropylmethyldimethoxysilane, 3-glycidoxypropyltriethoxysilane, 3-glycidoxypropylmethyldiethoxysilane, N-2-(aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-mercaptopropyltrimethoxysilane, 3-mercaptopropyltriethoxysilane, and allyltrimethoxysilane.

Of these, compounds in which Y has reactivity with the component (1) are preferred. Of the compounds, p-styryltrimethoxysilane, p-styryltriethoxysilane, vinyltrimethoxysilane, vinyltriethoxysilane, vinyltriisopropoxysilane, vinyltris(2-methoxyethoxy)silane, 3-acryloyloxypropyltrimethoxysilane, 3-methacryloyloxypropyltrimethoxysilane, 3-acryloyloxypropyltriethoxysilane, 3-methacryloyloxypropyltriethoxysilane, 3-acryloyloxypropylmethyldimethoxysilane, 3-methacryloyloxypropylmethyldimethoxysilane, 3-acryloyloxypropylmethyldiethoxysilane, and 3-methacryloyloxypropylmethyldiethoxysilane are preferred, 3-acryloyloxypropyltrimethoxysilane, 3-methacryloyloxypropyltrimethoxysilane, 3-acryloyloxypropyltriethoxysilane, 3-methacryloyloxypropyltriethoxysilane, 3-acryloyloxypropylmethyldimethoxysilane, 3-methacryloyloxypropylmethyldimethoxysilane, 3-acryloyloxypropylmethyldiethoxysilane, and 3-methacryloyloxypropylmethyldiethoxysilane, which are easily incorporated into a cured product during photo-curing reaction, are still more preferred, and 3-acryloyloxypropyltrimethoxysilane, 3-methacryloyloxypropyltrimethoxysilane, 3-acryloyloxypropylmethyldimethoxysilane, and 3-methacryloyloxypropylmethyldimethoxysilane are particularly preferred in consideration of the reactivity of an alkoxysilyl group.

The component (3) is preferably in a range of 0.01 part by weight to 8 parts by weight, still more preferably in a range of 0.1 part by weight to 5 parts by weight, based on 100 parts by weight of the total polymerizable components in the moisture-proof insulating coating of the present invention (II). The case of less than 0.01 part by weight based on 100 parts by weight of the total polymerizable components in the moisture-proof insulating coating of the present invention (II) may result in insufficient exhibition of adhesiveness to glass, a metal, or a metal oxide, and is not preferable. In addition, the case of more than 8% by weight based on 100 parts by weight of the total polymerizable components in the moisture-proof insulating coating of the present invention (II) results in a tendency to increase the surface tackiness of a cured product, depending on the kind of the silane coupling agent used.

The moisture-proof insulating coating of the present invention (II) can further contain a tackifying agent (component (4)) for the purpose of imparting adhesiveness to a base.

The tackifying agent used in the present invention (II) is a substance which is blended in a urethane acrylate or a high-molecular compound to be imparted with a tackifying function, is preferably a compound having a molecular weight of several hundreds to several thousands in an oligomer region, and preferably has the properties of being in a glass state at room temperature and not exhibiting rubber elasticity in itself.

A petroleum-based resin tackifying agent, a terpene-based resin tackifying agent, a rosin-based resin tackifying agent, a coumarone-indene resin tackifying agent, a styrenic resin tackifying agent, or the like can be generally used as the tackifying agent (4).

Examples of the petroleum-based resin tackifying agent include aliphatic petroleum resins, aromatic petroleum resins, aliphatic-aromatic copolymer-based petroleum resins, alicyclic petroleum resins, dicyclopentadiene resins, and modified products such as hydrogenated products thereof. The synthetic petroleum resins may be based on C5 or C9.

Examples of the terpene-based resin tackifying agent include β-pinene resin, α-pinene resin, terpene-phenol resins, aromatic modified terpene resins, and hydrogenated terpene resins. Most of the terpene-based resins are resins having no polar group.

Examples of the rosin-based resin tackifying agent include rosins such as gum rosin, tall oil rosin, and wood rosin; modified rosins such as hydrogenated rosins, disproportionated rosins, polymerized rosins, and malleinized rosins; and rosin esters such as rosin glycerol ester, hydrogenated rosin ester, and hydrogenated rosin glycerol ester. The rosin-based resins have a polar group.

The tackifying agents may be used singly or in combination of two or more kinds thereof.

Of the tackifying agent, at least one or more petroleum-based resin tackifying agents and terpene-based resin tackifying agents are preferably contained, and at least one or more petroleum-based resin tackifying agents are still more preferably contained.

It is desirable to contain 0.1 to 35 parts by weight of the component (4) in total amount based on 100 parts by weight of the total polymerizable components. A case in which the total amount of the component (4) is less than 0.1 part by weight based on 100 parts by weight of the total polymerizable components results in inhibited exhibition of the addition effect of the tackifying agent and is not preferable. In addition, a case in which the total amount of the component (4) is more than 35 parts by weight based on 100 parts by weight of the total polymerizable components can cause the moisture-proof insulating coating of the present invention (II) to become turbid or to have very high viscosity, and is not preferable.

The moisture-proof insulating coating of the present invention (II) can preferably contain a photopolymerization initiator (component (5)).

The component (5) which is a preferable component of the moisture-proof insulating coating of the present invention (II) is not particularly limited as long as the component (5) is a compound that generates a radical contributing initiation of radical polymerization by irradiation of light such as near-infrared rays, visible light rays, or ultraviolet rays.

Specific examples of the photopolymerization initiator include acetophenone, 2,2-dimethoxy-2-phenylacetophenone, diethoxyacetophenone, 1-hydroxycyclohexylphenylketone, 1,2-hydroxy-2-methyl-1-phenylpropane-1-one, α-hydroxycyclohexylphenylketone, 2-hydroxy-2-methyl-1-phenylpropanone, 2-hydroxy-2-methyl-1-(4-isopropylphenyl)propanone, 2-hydroxy-2-methyl-1-(4-dodecylphenyl)propanone, and 2-hydroxy-2-methyl-1-[(2-hydroxyethoxy)phenyl]propanone, benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonylbenzophenone, 4-benzoyl-4′-methyldiphenylsulfide, benzophenonetetracarboxylic acid or tetramethyl esters thereof, 4,4′-bis(dialkylamino)benzophenones (e.g., 4,4′-bis(dimethylamino)benzophenone, 4,4′-bis(dicyclohexylamino)benzophenone, 4,4′-bis(diethylamino)benzophenone, and 4,4′-bis(dihydroxyethylamino)benzophenone), 4-methoxy-4′-dimethylaminobenzophenone, 4,4′-dimethoxybenzophenone, 4-dimethylaminobenzophenone, 4-dimethylaminoacetophenone, benzyl, anthraquinone, 2-t-butylanthraquinone, 2-methylanthraquinone, phenanthraquinone, fluorenone, 2-benzyl-2-dimethylamino-1-(4-morpholinophenyl)-1-butanone, 2-(dimethylamino)-2-[(4-methylphenyl)methyl]-1-[4-(4-morpholinyl)phenyl]-1-butanone, 2-methyl-1-[4-(methylthio)phenyl]-2-morpholino-1-propanone, 2-hydroxy-2-methyl-[4-(1-methylvinyl)phenyl]propanol oligomer, benzoin, benzoin ethers (e.g., benzoin methyl ether, benzoin ethyl ether, benzoin propyl ether, benzoin isopropyl ether, benzoin isobutyl ether, benzoin phenyl ether, and benzyl dimethyl ketal), acridone, chloroacridone, N-methylacridone, N-butylacridone, N-butyl-chloroacridone, 2,4,6-trimethylbenzoyldiphenylphosphine oxide, 2,6-dimethoxybenzoyldiphenylphosphine oxide, 2,6-dichlorobenzoyldiphenylphosphine oxide, 2,4,6-trimethylbenzoylmethoxyphenylphosphine oxide, 2,4,6-trimethylbenzoylethoxyphenylphosphine oxide, 2,3,5,6-tetramethylbenzoyldiphenylphosphine oxide, and benzoyl di-(2,6-dimethylphenyl)phosphonate. Examples of bisacylphosphine oxides include bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-propylphenylphosphine oxide, bis-(2,6-dichlorobenzoyl)-1-naphthylphosphine oxide, bis-(2,6-dimethoxybenzoyl)phenylphosphine oxide, bis-(2,6-dimethoxybenzoyl)-2,4,4-trimethylpentylphosphine oxide, bis-(2,6-dimethoxybenzoyl)-2,5-dimethylphenylphosphine oxide, bis-(2,4,6-trimethylbenzoyl)phenylphosphine oxide, (2,5,6-trimethylbenzoyl)-2,4,4-trimethylpentylphosphine oxide, 2-isopropylthioxanthone, 4-isopropylthioxanthone, 2,4-diethylthioxanthone, 2,4-dichlorothioxanthone, and 1-chloro-4-propoxythioxanthone.

A metallocene compound can also be used as the photopolymerization initiator. A transition element of which representative examples are Fe, Ti, V, Cr, Mn, Co, Ni, Mo, Ru, Rh, Lu, Ta, W, Os, Ir, and the like can be used as a central metal for the metallocene compound. Examples of the metallocene compound include bis(η5-2,4-cyclopentadien-1-yl)-bis[2,6-difluoro-3-(pyrrol-1-yl) phenyl]titanium.

The photopolymerization initiators may be used singly or in combination of two or more kinds thereof.

The preferred photopolymerization initiator used in the present invention is a compound represented by Formula (1):

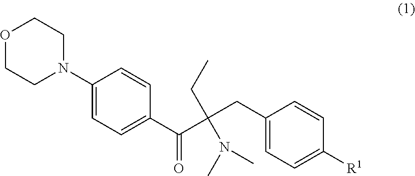

wherein R¹. represents H or CH₃.

The compound represented by Formula (1) is, e.g., 2-benzyl-2-dimethylamino-1-(4-morpholinophenyl)-1-butanone when R¹. is H, and 2-(dimethylamino)-2-[(4-methylphenyl)methyl]-1-[4-(4-morpholinyl)phenyl]-1-butanone when R¹ is a methyl group.

The content of the component (5) is preferably 0.1 to 10 parts by weight, more preferably 0.5 to 6 parts by weight, based on 100 parts by weight of total photopolymerizable components. The photopolymerization initiators may be used singly or in combination of two or more kinds thereof. A case in which the content of the component (5) is less than 0.1 part by weight based on 100 parts by weight of the total photopolymerizable components results in inhibited exhibition of photopolymerization initiation performance and is not preferable. In addition, a case in which the content of the component (5) is more than 10 parts by weight based on 100 parts by weight of the total photopolymerizable components can adversely affect the physical properties of a cured product and is not preferable.

A radical chain transfer agent can be used in the moisture-proof insulating coating of the present invention (II), if necessary.

As the radical chain transfer agent, a compound that has the function of reactivating polymerization active species trapped by an inert radical scavenger such as oxygen and contributes to improvement of surface curability can be used without limitation. Examples of the compound as the chain transfer agent include N,N-dimethylaniline, N,N-dimethyl-p-toluidine, N,N-dimethyl-m-toluidine, N,N-diethyl-p-toluidine, N,N-dimethyl-3,5-dimethylaniline, N,N-dimethyl-3,4-dimethylaniline, N,N-dimethyl-4-ethylaniline, N,N-dimethyl-4-isopropylaniline, N,N-dimethyl-4-t-butylaniline, butylaniline, N,N-bis(2-hydroxyethyl)-3,5-dimethylaniline, N,N-di(2-hydroxyethyl)-p-toluidine, N,N-bis(2-hydroxyethyl)-3,4-dimethylaniline, N,N-bis(2-hydroxyethyl)-4-ethylaniline, N,N-bis(2-hydroxyethyl)-4-isopropylaniline, N,N-bis(2-hydroxyethyl)-4-t-butylaniline, N,N-bis(2-hydroxyethyl)-3,5-di-isopropylaniline, N,N-bis(2-hydroxyethyl)-3,5-di-t-butylaniline, 4-N,N-dimethylaminobenzoic acid ethyl ester, 4-N,N-dimethylaminobenzoic acid methyl ester, N,N-dimethylaminobenzoic acid n-butoxyethyl ester, 4-N,N-dimethylaminobenzoic acid 2-(methacryloyloxy)ethyl ester, 4-N,N-dimethylaminobenzophenone, trimethylamine, triethylamine, N-methyldiethanolamine, N-ethyldiethanolamine, N-n-butyldiethanolamine, N-lauryldiethanolamine, triethanolamine, 2-(dimethylamino)ethyl methacrylate, N-methyldiethanolamine dimethacrylate, N-ethyldiethanolamine dimethacrylate, triethanolamine monomethacrylate, triethanolamine dimethacrylate, and triethanolamine trimethacrylate. Examples of particularly preferable amines include 2-ethylhexyl-4-dimethylaminobenzoate.

When the radical chain transfer agent is used in the moisture-proof insulating coating of the present invention (II), its content of 0.01 to 10 parts by weight based on 100 parts by weight of the total polymerizable components results in high sensitivity to improve surface curability in air. Still more preferably, the surface curability is further improved in a range of 0.5 to 5 parts by weight. Such radical chain transfer agents may be used singly or in combination of two or more kinds thereof.

The moisture-proof insulating coating of the present invention (II) preferable has a viscosity of 2000 mPa·s or less at 25° C. Still more preferably, the viscosity at 25° C. is 1600 mPa·s or less. When a curable composition is applied by a drawing application method using a dispenser, the viscosity of higher than 2000 mPa·s at 25° C. may inhibit the curable composition from spreading after the application and thus result in a too much increased thickness after curing.

A filler, a modifier, an antifoaming agent, a coloring agent, and the like can be added to the moisture-proof insulating coating of the present invention (II), if necessary, as long as fluidity and photo-curability are not adversely affected.

Examples of the filler include a fine silicon oxide powder, magnesium oxide, aluminum hydroxide, and calcium carbonate.

Examples of the modifier include leveling agents for improving leveling properties. As the leveling agents, for example, polyether-modified dimethylpolysiloxane copolymers, polyester-modified dimethylpolysiloxane copolymers, polyether-modified methylalkylpolysiloxane copolymers, aralkyl-modified methylalkylpolysiloxane copolymers, and the like can be used. These may be used singly or in combination of two or more kinds thereof. Based on 100 parts by weight of the total polymerizable components, 0.01 to 10 parts by weight of the leveling agent can be added. In the case of less than 0.01 part by weight, no addition effect of the leveling agent may be exhibited. In the case of more than 10 parts by weight, surface tackiness may be exhibited or electrical insulation characteristics may be deteriorated, depending on the kind of the leveling agent used.

The above antifoaming agent is not particularly limited as long as the antifoaming agent literally has the action of eliminating or suppressing generated or remaining bubbles when the moisture-proof insulating coating of the present invention (II) is applied.

Examples of the antifoaming agent used in the moisture-proof insulating coating of the present invention (II) include known antifoaming agents such as silicone-based oils, fluorine-containing compounds, polycarboxylic acid-based compounds, polybutadiene-based compounds, and acetylene diol-based compounds. Specific examples thereof include silicone-based antifoaming agents such as BYK-077 (manufactured by BYK Japan KK), SN-DEFOAMER 470 (manufactured by San Nopco Limited), TSA750S (manufactured by Momentive Performance Materials Inc.), and SILICONE OIL SH-203 (manufactured by Dow Corning Toray Co., Ltd.); acrylic polymer-based antifoaming agents such as DAPPO SN-348 (manufactured by San Nopco Limited), DAPPO SN-354 (manufactured by San Nopco Limited), DAPPO SN-368 (manufactured by San Nopco Limited), and DISPARLON 230HF (manufactured by Kusumoto Chemicals, Ltd.); acetylene diol-based antifoaming agents such as SURFYNOL DF-110D (manufactured by Nissin Chemical Industry Co., Ltd.) and SURFYNOL DF-37 (manufactured by Nissin Chemical Industry Co., Ltd.); and fluorine-containing silicone-based antifoaming agents such as FA-630. These may be used singly or in combination of two or more kinds thereof. In general, 0.001 to 5 parts by weight thereof can be added based on 100 parts by weight of the total polymerizable components. In the case of less than 0.01 part by weight, no addition effect of the antifoaming agent may be exhibited. In the case of more than 5 parts by weight, surface tackiness may be exhibited or electrical insulation characteristics may be deteriorated depending on the kind of the antifoaming agent to use.

Examples of the coloring agent include known inorganic pigments, organic pigments, and organic dyes, each of which is blended, depending on a desired color tone. These may be used singly or in combination of two or more kinds thereof.

The electronic component of the present invention (III) will be explained below.

The present invention (III) is an electronic component that is insulation-processed using the moisture-proof insulating coating of the present invention (II). Examples of the electronic component include microcomputers, transistors, condensers, resistances, relays, transformers, and the like, and packaged circuit boards carrying them, and can further include lead wires, harnesses, film substrates, and the like, joined to the electronic components.

Examples of the electronic component also include signal input units of flat panel display panels such as liquid crystal display panels, plasma display panels, organic electroluminescence panels, and field emission display panels. In particular, the moisture-proof insulating coating can be preferably used in IC peripheral units such as substrates for displays for electronic components, bonded-panel units, and the like.

The electronic component of the present invention (III) can be manufactured by applying the moisture-proof insulating coating of the present invention (II) to an electronic component and then curing the applied moisture-proof insulating coating to perform insulation processing.

In a specific method for manufacturing the electronic component of the present invention (III), first, the above-mentioned moisture-proof insulating coating is applied to the above electronic component by a generally known method such as an immersion method, a brush painting method, a spray method, or a drawing application method. Then, the electronic component is obtained by curing the coating film of the moisture-proof insulating coating applied to the electronic component by irradiation with ultraviolet rays by a high-pressure mercury lamp, a metal halide lamp, an LED, or the like as a light source. In particular, the manufacturing is performed by applying the moisture-proof insulating coating to an IC peripheral unit such as a substrate for a display panel for an electronic component, or a bonded-panel unit by a dispenser apparatus or the like, and by curing the moisture-proof insulating coating by irradiation with a needed level of ultraviolet rays using a lamp-system and LED-system UV irradiation apparatus.

### EXAMPLES

The present invention will be further specifically explained with reference to examples below, but is not limited only to the examples below.

### Synthesis Example 1

In a reaction vessel with a stirring machine and a water separator, 27.00 g of Sovermol® 908 (hydrogenated dimer diol manufactured by BASF, purity of hydrogenated dimer diol: 97.5% by weight), 17.10 g of EMPOL® 1008 (hydrogenated dimer acid manufactured by BASF, purity of hydrogenated dimer acid: 92.0%), and 0.01 g of NEOSTANN U-810 (dioctyltin dilaurate manufactured by Nitto Kasei Co., Ltd.) were put, a dehydration esterification reaction was conducted starting from about 240° C. and normal pressure while allowing condensed water to flow and reducing the pressure, and a mixture of a polyester polyol belonging to the component (a) with a hydrogenated dimer diol, having a hydroxyl value of 59 mgKOH/g and a number average molecular weight of 2000 and containing 15% by weight of the hydrogenated dimer diol, (hereinafter referred to as “polyester polyol A”) was obtained.

### Synthesis Example 2

In a 300-mL reaction vessel with a stirrer, a thermometer, and a capacitor, 45.00 g of the polyester polyol A, 17.94 g of Sovermol® 908 (hydrogenated dimer diol manufactured by BASF, purity of hydrogenated dimer diol: 97.5% by weight), 0.82 g of NONION® L-2 (polyethylene glycol monolaurate manufactured by NOF CORPORATION), 0.12 g of Irganox® 1010 (pentaerythritol tetrakis[3-(3,5-di-tert-butyl-4-hydroxyphenyl)]propionate manufactured by BASF), 0.01 g of NEOSTANN U-810 (dioctyltin dilaurate manufactured by Nitto Kasei Co., Ltd.), and 32.62 g of VESTANAT® H12MDI (methylene bis(4-cyclohexylisocyanate) manufactured by Evonik Degussa GmbH) as a polyisocyanate compound belonging to the component (b) were charged, and heated to 75 to 80° C. using an oil bath while stirring. Then, the reaction was continued while stirring for 2.5 hours. Then, 20.69 g of 4-HBA (4-hydroxybutylacrylate manufactured by Osaka Organic Chemical Industry Ltd.) as a hydroxyl group-containing (meth)acrylate belonging to the component (c) was charged into the reaction vessel, and the reaction was continued for 10 hours while continuing stirring and maintaining the temperature in the reaction vessel in a range of 80° C.±5° C. Then, an infrared absorption spectrum was measured, the absorption of an isocyanate group was confirmed to be lost, the reaction was finished, and a composition (hereinafter referred to as “composition b”) containing a urethane acrylate belonging to the present invention (I) (hereinafter referred to as “urethane acrylate B”) was obtained. The composition b contains 14.5% by weight of a compound represented by Formula (8).

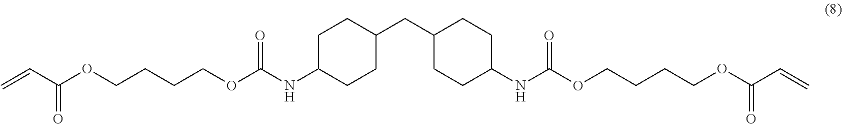 [SMILES: C=CC(=O)OCCCCOC(=O)NC1CCC(CC2CCC(NC(=O)OCCCCOC(=O)C=C)CC2)CC1]

### Synthesis Example 3

In a 300-mL reaction vessel with a stirrer, a thermometer, and a capacitor, 45.00 g of the polyester polyol A, 17.94 g of Sovermol® 908 (hydrogenated dimer diol manufactured by BASF, purity of hydrogenated dimer diol: 97.5% by weight), 0.82 g of NONION® L-2 (polyethylene glycol monolaurate manufactured by NOF CORPORATION), 0.12 g of Irganox® 1010 (pentaerythritol tetrakis[3-(3,5-di-tert-butyl-4-hydroxyphenyl)]propionate manufactured by BASF), 0.01 g of NEOSTANN U-810 (dioctyltin dilaurate manufactured by Nitto Kasei Co., Ltd.), and 27.64 g of VESTANAT® IPDI (3-isocyanatomethyl-3,5,5-trimethylcyclohexylisocyanate manufactured by Evonik Degussa GmbH) as a polyisocyanate compound belonging to the component (b) were charged, and heated to 75 to 80° C. using an oil bath while stirring. Then, the reaction was continued while stirring for 2.5 hours. Then, 20.69 g of 4-HBA (4-hydroxybutylacrylate manufactured by Osaka Organic Chemical Industry Ltd.) as a hydroxyl group-containing (meth)acrylate belonging to the component (c) was charged into the reaction vessel, and the reaction was continued for 10 hours while continuing stirring and maintaining the temperature in the reaction vessel in a range of 80° C.±5° C. Then, an infrared absorption spectrum was measured, the absorption of an isocyanate group was confirmed to be lost, the reaction was finished, and a composition (hereinafter referred to as “composition c”) containing a urethane acrylate belonging to the present invention (I) (hereinafter referred to as “urethane acrylate C”) was obtained. The composition c contains 14.8% by weight of a compound represented by Formula (9).

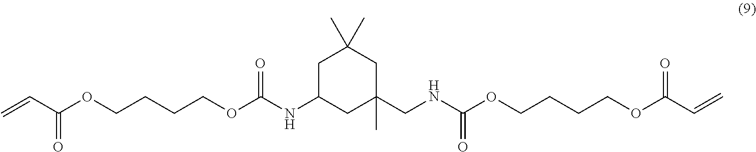 [SMILES: C=CC(=O)OCCCCOC(=O)NCC1(C)CC(NC(=O)OCCCCOC(=O)C=C)CC(C)(C)C1]

### Synthesis Example 4

In a 300-mL reaction vessel with a stirrer, a thermometer, and a capacitor, 45.00 g of the polyester polyol A, 17.94 g of Sovermol® 908 (hydrogenated dimer diol manufactured by BASF, purity of hydrogenated dimer diol: 97.5% by weight), 0.82 g of NONION® L-2 (polyethylene glycol monolaurate manufactured by NOF CORPORATION), 0.12 g of Irganox⁶ 1010 (pentaerythritol tetrakis[3-(3,5-di-tert-butyl-4-hydroxyphenyl)]propionate manufactured by BASF), 0.01 g of NEOSTANN U-810 (dioctyltin dilaurate manufactured by Nitto Kasei Co., Ltd.), and 25.64 g of COSMONATE® NBDI (2,5(2,6)-bis(isocyanatomethyl)dicyclo[2,2,1]heptane manufactured by Mitsui Chemicals, Inc.) as a polyisocyanate compound belonging to the component (b) were charged, and heated to 75 to 80° C. using an oil bath while stirring. Then, the reaction was continued while stirring for 2.5 hours. Then, 20.69 g of 4-HBA (4-hydroxybutylacrylate manufactured by Osaka Organic Chemical Industry Ltd.) as a hydroxyl group-containing (meth)acrylate belonging to the component (c) was charged into the reaction vessel, and the reaction was continued for 10 hours while continuing stirring and maintaining the temperature in the reaction vessel in a range of 80° C.±5° C. Then, an infrared absorption spectrum was measured, the absorption of an isocyanate group was confirmed to be lost, the reaction was finished, and a composition (hereinafter referred to as “composition d”) containing a urethane acrylate belonging to the present invention (I) (hereinafter referred to as “urethane acrylate D”) was obtained. The composition d contains 14.6% by weight of a compound represented by Formula (10).

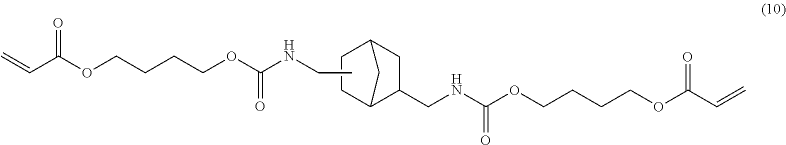

### Comparative Synthesis Example 1

In a reaction vessel with a stirring machine and a water separator, 6.60 g of 1,6-hexanediol (manufactured by Tokyo Chemical Industry Co., Ltd.), 25.00 g of EMPOL® 1008 (hydrogenated dimer acid manufactured by BASF, purity of hydrogenated dimer acid: 92.0%), 1.25 g of lauric acid (manufactured by Tokyo Chemical Industry Co., Ltd.), and 0.5 mg of dibutyltin dilaurate (manufactured by Tokyo Chemical Industry Co., Ltd.) were put, a dehydration esterification reaction was conducted starting from about 240° C. and normal pressure while allowing condensed water to flow and reducing the pressure, and a polyester polyol having a hydroxyl value of 56 mgKOH/g and a number average molecular weight of 2000 (hereinafter referred to as “polyester polyol E”) was obtained.

### Comparative Synthesis Example 2

In a 300-mL reaction vessel with a stirrer, a thermometer, and a capacitor, 50.00 g of the polyester polyol E, 0.05 g of Irganox® 1010 (pentaerythritol tetrakis[3-(3,5-di-tert-butyl-4-hydroxyphenyl)]propionate manufactured by BASF), 6 mg of dibutyltin dilaurate (manufactured by Tokyo Chemical Industry Co., Ltd.), 6.3 g of DURANATE 50M-HDI (hexamethylene diisocyanate manufactured by Asahi Kasei Corp.), and 59.20 g of FA-512AS (dicyclopentadieneoxyethyl acrylate manufactured by Hitachi Chemical Company, Ltd.) were charged, and heated to 75 to 80° C. using an oil bath while stirring. Then, the reaction was continued while stirring for 5 hours. Then, 2.90 g of HEA (2-hydroxyethylacrylate manufactured by Osaka Organic Chemical Industry Ltd.), 0.06 g of hydroquinone monomethyl ether (manufactured by Wako Pure Chemical Industries, Ltd.), and 24 mg of dibutyltin dilaurate (manufactured by Tokyo Chemical Industry Co., Ltd.) were charged into the reaction vessel, and the reaction was continued for 2 hours while continuing stirring and maintaining the temperature in the reaction vessel in a range of 80° C.±5° C. Then, an infrared absorption spectrum was measured, and the absorption of an isocyanate group was confirmed to be lost. Then, 3.56 g of Irgacure® 184 (1-hydroxycyclohexylphenylketone manufactured by BASF) and 1.19 g of Irgacure® 819 (bis(2,4,6-trimethylbenzoyl)phenylphosphine oxide manufactured by BASF) were added and stirred to obtain a photocurable composition E1 containing a urethane acrylate.

### Comparative Synthesis Example 3

In a 300-mL reaction vessel with a stirrer, a thermometer, and a capacitor, 55.00 g of TESLAC® 2470 (polyester polyol containing diethylene glycol and a dimer acid as main components, manufactured by Hitachi Kasei Polymer Co., Ltd.) and 12.50 g of MILIONATE® MT (diphenylmethane diisocyanate manufactured by Nippon Polyurethane Industry Co., Ltd.) were charged, and heated to 110° C. using an oil bath while stirring under nitrogen atmosphere. Then, the reaction was continued while stirring for 2 hours. Then, 4.65 g of HEA (2-hydroxyethylacrylate manufactured by Osaka Organic Chemical Industry Ltd.) was charged into the reaction vessel, and the reaction was continued for 2 hours while stirring under oxygen atmosphere and maintaining the temperature in the reaction vessel at 110° C. Then, an infrared absorption spectrum was measured, and the absorption of an isocyanate group was confirmed to be lost. Then, 2.15 g of Irgacure® 184 (1-hydroxycyclohexylphenylketone manufactured by BASF) was added and stirred to obtain a photocurable composition E2 containing a urethane acrylate.

### Comparative Synthesis Example 4

An air gas was introduced into a reaction vessel equipped with a stirrer, a thermometer, a cooling pipe, and an air gas introduction pipe, and 53.00 g of HEA (2-hydroxyethyl acrylate manufactured by Osaka Organic Chemical Industry Ltd.), 600.00 g of GI-1000 (hydrogenated polybutadiene diol manufactured by Nippon Soda Co., Ltd., number average molecular weight: about 1,500), and 0.50 g of hydroquinone monomethyl ether (manufactured by Wako Pure Chemical Industries, Ltd. Co., Ltd.) were then charged, and heated to 70° C. using an oil bath. Then, they were kept warm at 70 to 75° C. for 30 minutes while stirring, and 70.00 g of CORONATE® T-65 (tolylene diisocyanate manufactured by Nippon Polyurethane Industry Co., Ltd.) was homogeneously dropwise added to the resultant for 3 hours. After the dropwise addition, the resultant was kept warm at 70 to 75° C. for about 5 hours while stirring, and the reaction was continued. Then, an infrared absorption spectrum was measured, the absorption of an isocyanate group was confirmed to be lost, the reaction was finished, and a urethane acrylate (hereinafter referred to as a urethane acrylate F) was obtained.

### Blending Example 1

Using THINKY MIXER ARE-310 (planetary centrifugal mixer manufactured by THINKY CORPORATION), 10.00 g of the composition b, 11.00 g of IBXA (isobornyl acrylate manufactured by Osaka Organic Chemical Industry Ltd.), 3.75 g of BLEMMER LA (lauryl acrylate manufactured by NOF CORPORATION), 0.25 g of A-DCP (tricyclodecane diacrylate manufactured by Shin Nakamura Chemical Co., Ltd.), 0.69 g of Irgacure® 369 (2-benzyl-2-dimethylamino-1-(4-morpholinophenyl)butanone-1 manufactured by BASF) as a photopolymerization initiator, and 0.06 g of DISPALON L-1982N (acrylic copolymer manufactured by Kusumoto Chemicals, Ltd.) as an antifoaming agent were mixed. The blend was regarded as a photocurable moisture-proof insulating coating B1. The viscosity of the photocurable moisture-proof insulating coating B1 at 25° C. was 600 mPa·s.

### Blending Example 2

Using THINKY MIXER ARE-310 (planetary centrifugal mixer manufactured by THINKY CORPORATION), 10.00 g of the composition b, 11.00 g of IBXA (isobornyl acrylate manufactured by Osaka Organic Chemical Industry Ltd.), 3.75 g of BLEMMER LA (lauryl acrylate manufactured by NOF CORPORATION), 0.25 g of A-DCP (tricyclodecane diacrylate manufactured by Shin Nakamura Chemical Co., Ltd.), 0.69 g of Irgacure® 369 (2-benzyl-2-dimethylamino-1-(4-morpholinophenyl)butanone-1 manufactured by BASF) as a photopolymerization initiator, 0.06 g of DISPALON L-1982N (acrylic copolymer manufactured by Kusumoto Chemicals, Ltd.) as an antifoaming agent, and 0.03 g of methacryloyloxy propyl trimethoxysilane as a silane coupling agent were mixed. The blend was regarded as a photocurable moisture-proof insulating coating B2. The viscosity of the photocurable moisture-proof insulating coating B2 at 25° C. was 590 mPa·s.

### Blending Example 3

Using THINKY MIXER ARE-310 (planetary centrifugal mixer manufactured by THINKY CORPORATION), 10.00 g of the composition b, 11.00 g of IBXA (isobornyl acrylate manufactured by Osaka Organic Chemical Industry Ltd.), 3.75 g of BLEMMER LA (lauryl acrylate manufactured by NOF CORPORATION), 0.25 g of A-DCP (tricyclodecane diacrylate manufactured by Shin Nakamura Chemical Co., Ltd.), 0.69 g of Irgacure® 369 (2-benzyl-2-dimethylamino-1-(4-morpholinophenyl)butanone-1 manufactured by BASF) as a photopolymerization initiator, 0.06 g of DISPALON L-1982N (acrylic copolymer manufactured by Kusumoto Chemicals, Ltd.) as an antifoaming agent, and 1.00 g of 1-MARV S-110 (hydrogenated petroleum resin manufactured by Idemitsu Kosan Co., Ltd.) as a tackifying agent were mixed. The blend was regarded as a photocurable moisture-proof insulating coating B3. The viscosity of the photocurable moisture-proof insulating coating B3 at 25° C. was 650 mPa·s.

### Blending Example 4

Using THINKY MIXER ARE-310 (planetary centrifugal mixer manufactured by THINKY CORPORATION), 10.00 g of the composition c, 11.00 g of IBXA (isobornyl acrylate manufactured by Osaka Organic Chemical Industry Ltd.), 3.75 g of BLEMMER LA (lauryl acrylate manufactured by NOF CORPORATION), 0.25 g of A-DCP (tricyclodecane diacrylate manufactured by Shin Nakamura Chemical Co., Ltd.), 0.69 g of Irgacure® 369 (2-benzyl-2-dimethylamino-1-(4-morpholinophenyl)butanone-1 manufactured by BASF) as a photopolymerization initiator, and 0.06 g of DISPALON L-1982N (acrylic copolymer manufactured by Kusumoto Chemicals, Ltd.) as an antifoaming agent were mixed. The blend was regarded as a photocurable moisture-proof insulating coating C1. The viscosity of the photocurable moisture-proof insulating coating C1 at 25° C. was 500 mPa·s.

### Blending Example 5

Using THINKY MIXER ARE-310 (planetary centrifugal mixer manufactured by THINKY CORPORATION), 9.25 g of the composition d, 12.00 g of IBXA (isobornyl acrylate manufactured by Osaka Organic Chemical Industry Ltd.), 3.75 g of BLEMMER LA (lauryl acrylate manufactured by NOF CORPORATION), 0.69 g of Irgacure® 369 (2-benzyl-2-dimethylamino-1-(4-morpholinophenyl)butanone-1 manufactured by BASF) as a photopolymerization initiator, and 0.06 g of DISPALON L-1982N (acrylic copolymer manufactured by Kusumoto Chemicals, Ltd.) as an antifoaming agent were mixed. The blend was regarded as a photocurable moisture-proof insulating coating D1. The viscosity of the photocurable moisture-proof insulating coating D1 at 25° C. was 290 mPa·s.

### Comparative Blending Example 1

An air gas was introduced into a reaction vessel equipped with a stirrer, a thermometer, a cooling pipe, and an air gas introduction pipe, and 40.00 g of the urethane acrylate F, 5.00 g of A-9550 (dipentaerythritol hexaacrylate manufactured by Shin Nakamura Chemical Co., Ltd.), 50.00 g of IBXA (isobornyl acrylate manufactured by Osaka Organic Chemical Industry Ltd.), and 5.00 g of BLEMMER LA (lauryl acrylate manufactured by NOF CORPORATION) were then put, heated to 70° C., then kept warm at 70 to 75° C. for 3 hours, and homogeneously stirred and mixed. Further, 4.00 g of Irgacure® 369 (2-benzyl-2-dimethylamino-1-(4-morpholinophenyl)butanone-1 manufactured by BASF) was added, stirred, and dissolved to obtain a photocurable composition. Further, 3.00 g of Y-5187 (γ-isocyanatepropylmethoxysilane manufactured by Momentive Performance Materials Japan LLC) was added, stirred, and dissolved. Then, 0.50 g of TSA750S (antifoaming agent manufactured by Momentive Performance Materials Inc.) was added, and mixed using a spatula, and the blend was regarded as a photocurable composition F1.

### Comparative Blending Example 2

An air gas was introduced into a reaction vessel equipped with a stirrer, a thermometer, a cooling pipe, and an air gas introduction pipe, and 40.00 g of BLEMMER LA (lauryl acrylate manufactured by NOF CORPORATION) and 2.50 g of Irgacure® 651 (benzyl dimethyl ketal manufactured by BASF) were then charged, stirred at 110° C. for 45 minutes, and dissolved. Then, 50.00 g of TEAI-1000 (acryl-modified hydrogenated polybutadiene resin manufactured by Nippon Soda Co., Ltd., number average molecular weight: about 1000, hydrogenation rate: 97%), 10.00 g of BP-4PA (bisphenol A propylene glycol adduct diacrylate manufactured by Kyoeisha Chemical Co., Ltd.), and 5.00 g of Y-5187 (γ-isocyanatepropylmethoxysilane manufactured by Momentive Performance Materials Japan LLC) were added to the solution, stirred at 90° C. for 140 minutes, and mixed. Then, 0.50 g of TSA750S (antifoaming agent manufactured by Momentive Performance Materials Inc.) was added, and mixed using a spatula, and the blend was regarded as a photocurable composition F2.

<Measurement of Viscosity>

Viscosity was measured by the following method.

Using 10 mL of a sample, a value was measured when viscosity was substantially constant under conditions of a temperature of 25.0° C. and a rotation number of 20 rpm with a viscometer (model: DV-II+Pro, manufactured by

Brookfield) using a small sample adapter and a spindle with a model number of C4-31.

<Evaluation of Adhesiveness to Glass>

Adhesiveness to glass was evaluated by the following method.

Each of the photocurable moisture-proof insulating coatings B1 to B3, C1, and D1, and the photocurable compositions E1 to E2 and F1 to F2 was applied onto glass so as to have a thickness of 150 μm after drying, irradiated with ultraviolet rays using a conveyer-type UV irradiation apparatus (trade name: CSN2-40, manufactured by GS Yuasa International Ltd.) with a high-pressure mercury lamp under a condition of an irradiation dose of 1500 mJ/cm² (value at 365 nm), cured, heated at 50° C. for 6 hours, and then left standing at room temperature for 12 hours. For the coating films, only one end of a cured film for an evaluation test was peeled to produce a test piece for adhesion measurement having a width of 2.5 mm. Adhesive strength was determined by performing fixation on a tensile tester (EZ Test/CE manufactured by SHIMADZU CORPORATION) so that the angle between the glass plate and the peeled cured film is 90°, setting a first spacing between chucks at 7 mm, and measuring 90° peel strength at a rate of 50 mm/min at 23° C. The results are listed in Table 1.

<Evaluation of Adhesiveness to Polyimide Film>

Adhesiveness to a polyimide film was evaluated by the following method.

Each of the photocurable moisture-proof insulating coatings B1 to B3, C1, and D1, and the photocurable compositions E1 to E2 and F1 to F2 was applied onto a polyimide film (trade name: KAPTON® 150EN, manufactured by DU PONT-TORAY CO., LTD.) so as to have a thickness of 150 μm after drying, irradiated with ultraviolet rays using a conveyer-type UV irradiation apparatus (trade name: CSN2-40, manufactured by GS Yuasa International Ltd.) with a high-pressure mercury lamp under a condition of an irradiation dose of 1500 mJ/cm² (value at 365 nm), cured, heated at 50° C. for 6 hours, and then left standing at room temperature for 12 hours. For the coating films, only one end of a cured film for an evaluation test was peeled to produce a test piece for adhesion measurement having a width of 2.5 mm. Adhesive strength was determined by performing fixation on a tensile tester (EZ Test/CE manufactured by SHIMADZU CORPORATION) so that the angle between the polyimide film and the peeled cured film is 180°, setting a first spacing between chucks at 10 mm, and measuring 180° peel strength at a rate of 50 mm/min at 23° C. The results are listed in Table 1.

<Evaluation of Long-Term Electrical Insulation Reliability Using Flexible Substrate>

Each of the photocurable moisture-proof insulating coatings B1 to B3, C1, and D1, and the photocurable compositions E1 to E2 and F1 to F2 was applied to a flexible circuit board obtained by tinning treatment of a substrate with a fine comb pattern shape (copper wiring line width/width between copper wiring lines=15 μm/15 μm) described in JPCA-ET01, produced by etching a flexible copper clad laminate (manufactured by Sumitomo Metal Mining Co., Ltd., grade name: S′PERFLEX, copper thickness: 8 μm, polyimide thickness: 38 μm), so as to have a thickness of 150 μm after drying, irradiated with ultraviolet rays using a conveyer-type UV irradiation apparatus (trade name: CSN2-40, manufactured by GS Yuasa International Ltd.) with a high-pressure mercury lamp under a condition of an irradiation dose of 1500 mJ/cm² (value at 365 nm), cured, heated at 50° C. for 6 hours, and then left standing at room temperature for 12 hours.

A bias voltage of 30 V was applied using the test piece, and a temperature-humidity routine test under conditions of a temperature of 85° C. and a humidity RH of 85% was conducted using MIGRATION TESTER MODEL MIG-8600 (manufactured by IMV). Resistance values measured 1000 hours after the start of the above temperature-humidity routine test are listed in Table 1.

### <Evaluation of Long-Term Insulation Reliability Using Wiring Line on Glass Substrate>

Each of the photocurable moisture-proof insulating coatings B1 to B3, C1, and D1, and the photocurable compositions E1 to E2 and F1 to F2 was applied onto a pattern electrode, in which an ITO wiring line having a comb pattern shape with line/space of 40 μm/10 μm was formed on a glass substrate, so as to have a thickness of 150 μm after drying, irradiated with ultraviolet rays using a conveyer-type UV irradiation apparatus (trade name: CSN2-40, manufactured by GS Yuasa International Ltd.) with a high-pressure mercury lamp under a condition of an irradiation dose of 1500 mJ/cm² (value at 365 nm), cured, heated at 50° C. for 6 hours, and then left standing at room temperature for 12 hours.

A bias voltage of 30 V was applied using the test piece, and a temperature-humidity routine test under conditions of a temperature of 85° C. and a humidity RH of 85% was conducted using MIGRATION TESTER MODEL MIG-8600 (manufactured by IMV). Resistance values measured in the early stage of the start of the above temperature-humidity routine test and 1000 hours after the start of the above temperature-humidity routine test are listed in Table 1.

TABLE 1

| Coating/composition name | | B1 | B2 | B3 | C1 | D1 | E1 | E2 | F1 | F2 |
|---|---|---|---|---|---|---|---|---|---|---|
| Viscosity/mPa · s | | 600 | 590 | 650 | 500 | 290 | — | — | — | — |
| Glass adhesion | | 4.8 | 6.5 | 5.0 | 5.0 | 4.9 | 3.2 | 5.0 | 2.5 | 1.5 |
| strength/N · cm⁻¹ | | | | | | | | | | |
| Polyimide adhesion | | 3.1 | 3.1 | 3.3 | 3.3 | 4.0 | 2.8 | 4.0 | 0.2 | 0.1 |
| strength/N · cm⁻¹ | | | | | | | | | | |
| Resistance value | Flexible | 1.6 × 10¹¹ | 1.6 × 10¹¹ | 1.5 × 10¹¹ | 1.3 × 10¹¹ | 1.0 × 10¹¹ | Short | Short | 2.2 × 10¹² | 3.8 × 10¹² |
| (Ω) after 1,000 | substrate | | | | | | circuit | circuit | | |
| hours in long-term | Glass | 2.5 × 10⁹ | 2.4 × 10⁹ | 2.4 × 10⁹ | 2.4 × 10⁹ | 2.5 × 10⁹ | Short | Short | 5.3 × 10¹⁰ | 5.4 × 10¹⁰ |
| insulation | substrate | | | | | | circuit | circuit | | |
| reliability test | | | | | | | | | | |

The results of Table 1 reveal that the photocurable moisture-proof insulating coatings B1 to B3, C1, and D1 have good adhesiveness to glass and polyimide, and also have high long-term insulation reliability. In contrast, the photocurable compositions E1 to E2 have significantly low long-term insulation reliability. In addition, the photocurable compositions F1 to F2 have significantly low adhesion strength to polyimide. In addition, the photocurable moisture-proof insulating coatings B1 to B3, C1, and D1 also have good handleability because of having viscosity suitable for application thereof using a dispenser. In other words, it was found that the photocurable moisture-proof insulating coating of the present invention (II) produced using the urethane (meth)acrylate of the present invention (I) has good handleability, and a cured film obtained by curing the photocurable moisture-proof insulating coating not only has good adhesiveness to glass and polyimide, but also exhibits long-term insulation reliability at a high level, compared to a cured film obtained by curing a photocurable composition produced with a urethane (meth)acrylate in the related art.

### INDUSTRIAL APPLICABILITY

The photocurable moisture-proof insulating coating of the present invention (II) produced using the urethane (meth)acrylate of the present invention (I) has a small environmental load, high long-term insulation reliability, and, besides, sufficient adhesiveness to a substrate material. In addition, the electronic component of the present invention (III), insulation-processed using the moisture-proof insulating coating of the present invention (II), has high reliability, and is useful for microcomputers and packaged circuit boards carrying various components.

1. A urethane (meth)acrylate obtained by allowing
(a) a polyester polyol having a structural unit derived from a hydrogenated dimer acid and a structural unit derived from a hydrogenated dimer diol;
(b) a polyisocyanate compound; and
(c) a hydroxyl group-containing (meth)acrylate to react.

2. The urethane (meth)acrylate according to claim 1, wherein the polyester polyol (a) comprises not less than 80% by weight of the structural unit derived from the hydrogenated dimer acid based on the total amount of a structural unit derived from a polycarboxylic acid, and not less than 80% by weight of the structural unit derived from the hydrogenated dimer diol based on the total amount of a structural unit derived from a polyol.

3. The urethane (meth)acrylate according to claim 1, wherein the polyisocyanate compound (b) is at least one selected from the group consisting of norbornane diisocyanate, isophorone diisocyanate, and methylene bis(4-cyclohexylisocyanate).

4. A moisture-proof insulating coating comprising:
(1) the urethane (meth)acrylate according to claim 1; and
(2) a (meth)acryloyl group-containing compound that does not contain any silicon atom.

5. The moisture-proof insulating coating according to claim 4, further comprising
(3) a silane coupling agent.

6. The moisture-proof insulating coating according to claim 4, further comprising
(4) a tackifying agent.

7. The moisture-proof insulating coating according to claim 4, further comprising
(5) a photopolymerization initiator.

8. The moisture-proof insulating coating according to claim 4, wherein the total amount of a (meth)acryloyl group-containing compound that has a chain aliphatic hydrocarbon group having not less than 9 carbon atoms and does not contain any silicon atom and a liquid (meth)acryloyl group-containing compound that has a cyclic aliphatic hydrocarbon group having not less than 9 carbon atoms and does not contain any silicon atom is not less than 50% by weight based on the total amount of the (meth)acryloyl group-containing compound (2) that does not any silicon atom.

9. The moisture-proof insulating coating according to claim 6, wherein the tackifying agent (4) comprises a petroleum resin-based tackifying agent.

10. The moisture-proof insulating coating according to claim 7, wherein the photopolymerization initiator (5) is a compound represented by Formula (1) 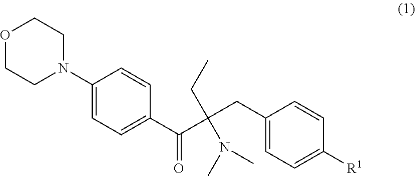
wherein R¹ represents H or CH₃.

11. The moisture-proof insulating coating according to claim 4, comprising 30 to 75% by weight of the (meth)acryloyl group-containing compound (2) that does not contain any silicon atom based on total polymerizable components.

12. The moisture-proof insulating coating according to claim 5, comprising 0.01 to 8 parts by weight of the silane coupling agent (3) based on 100 parts by weight of total polymerizable components.

13. The moisture-proof insulating coating according to claim 6, comprising 0.1 to 35 parts by weight of the tackifying agent (4) based on 100 parts by weight of total polymerizable components.

14. The moisture-proof insulating coating according to claim 7, comprising 0.1 to 10 parts by weight of the photopolymerization initiator (5) based on 100 parts by weight of total polymerizable components.

15. An electronic component insulation-processed using the moisture-proof insulating coating according to claim 4.

16. A moisture-proof insulating coating comprising:
(1) the urethane (meth)acrylate according to claim 2; and
(2) a (meth)acryloyl group-containing compound that does not contain any silicon atom.

17. A moisture-proof insulating coating comprising:
(1) the urethane (meth)acrylate according to claim 3; and
(2) a (meth)acryloyl group-containing compound that does not contain any silicon atom.
